(19) United States
(12) Patent Application Publication
(10) Pub. No.: US 2005/0159853 A1
(43) Pub. Date: Jul. 21, 2005

(54) Driving status detection device and related method

(75) Inventors: Toshiaki Takahashi, Yokahama-shi (JP); Hirofumi Inoue, Yokosuka-shi (JP); Hidenori Seguchi, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/032,064

(22) Filed: Jan. 11, 2005

(30) Foreign Application Priority Data
Jan. 15, 2004 (JP) P2004-008028
Feb. 5, 2004 (JP) P2004-029222
Feb. 5, 2004 (JP) P2004-029773

(51) Int. Cl. G06F 17/00

(52) U.S. Cl. 701/1; 340/439

(57) ABSTRACT

In a driving status detection device and method for detecting a characteristic driving status during a drive of a vehicle, a vehicle speed is detected, a differentiated value of second order of the vehicle speed within a given time interval is calculated and a risk occurrence scene, which is a driving status at a high risk for a driver, is detected based on the differentiated value of second order of the vehicle speed.

### BACKGROUND OF THE INVENTION

The present invention relates to a driving status detection device and a related method and, more particularly, to a driving status detection device and its related method that detects a characteristic driving status of a vehicle during a drive of a vehicle.

Recently, proposals have heretofore been made to provide an operation data management system by which behavior of a moving object, such as vehicles and railroad trains, are managed. Such a system has a structure wherein measured data, related to behavior of the moving object, is registered and measured data after registration is analyzed for acquiring a vehicle behavior.

Japanese Patent application Laid-Open Publication No. 2000-185676 discloses a device wherein high-risk behavior of a vehicle is detected to analyze a driving tendency for each driver. In particular, a structure is disclosed wherein comparison is made between a conditioning pattern, under which vehicle behavior is recognized as high-risk behavior, and behavior actually detected by a sensor section and only information, related to vehicle behavior that satisfies the conditioning pattern, is registered in a memory card for each high-risk behavior for statistic analysis.

### SUMMARY OF THE INVENTION

However, upon studies conducted by the present inventors, though such a structure is absolutely aimed at a frequency in the occurrence of high-risk behavior to enable analysis of a tendency, such as the degree of carefulness of the driver or sharpness in acceleration and deceleration, in driving operation of a driver, no consideration is undertaken for a condition with no concentration in driving operation of the driver, that is, for detection of so-called driver distraction. With this view in mind, it is conceived that no consideration is undertaken for the detection of risk occurrence scene forming a driving status with a high risk for the driver such as driver distraction. As used herein, the term “driver distraction” refers to a condition under which the driver has diminished attention with no concentration in driving operation.

Further, such a structure takes no measures against the occurrence of wavering, in the driving operation, of the driver caused when the driver encounters a difficult or weak driving status, such as when turning left through the occurrence of a break in a line of pedestrian crossing persons. From such a viewpoint, it is conceived that no consideration is undertaken for detecting a risk occurrence scene, such as the difficult driving status for the driver, which represents a driving status with a high risk for the driver.

Furthermore, it is conceived that such a structure takes nothing for detecting the risk occurrence scene with the high risk, such as jumbling in the driving operation resulting from delayed finding of an obstacle or avoiding the obstacle.

The present invention has been completed upon conduction of the above studies by the present inventors and has an object to provide a driving status detection device and its related method that are able to detect driver distraction forming a risk occurrence scene in a more reliable manner.

Further, it is an object of the present invention to provide a driving status detection device and its related method that are able to detect a driving status difficult for a driver, forming a risk occurrence scene, in a more reliable manner.

Furthermore, it is an object of the present invention to provide a driving status detection device and its related method that are able to detect a risk occurrence scene, forming a driving status with high risk, which occurs on a vehicle to enable a driver to use a detected risk occurrence scene as a guide to be helpful in subsequent driving.

To achieve the above object, one aspect of the present invention provides a driving status detection device detecting a characteristic driving status during a drive of a vehicle, comprising: a vehicle speed detector detecting a vehicle speed; a processing section calculating a differentiated value of second order of the vehicle speed within a given time interval; and a detecting section detecting a risk occurrence scene that is a driving status at a high risk for a driver based on the differentiated value of second order of the vehicle speed.

On other wards, another aspect of the present invention provides a driving status detection device detecting a characteristic driving status during a drive of a vehicle, comprising: vehicle speed detection means for detecting a vehicle speed; calculating means for calculating a differentiated value of second order of the vehicle speed within a given time interval; and detecting means for detecting a risk occurrence scene that is a driving status at a high risk for a driver based on the differentiated value of second order of the vehicle speed.

Besides, another aspect of the present invention provides a driving status detection method detecting a characteristic driving status during a drive of a vehicle, comprising: detecting a vehicle speed; calculating a differentiated value of second order of the vehicle speed within a given time interval; and detecting a risk occurrence scene that is a driving status at a high risk for a driver based on the differentiated value of second order of the vehicle speed.

Other and further features, advantages, and benefits of the present invention will become more apparent from the following description taken in conjunction with the following drawings.

### BRIEF DESCRIPTION OF THE DRAWINGS

FIG. 1 is a block diagram illustrating a structure of a driving status detection device of a first embodiment according to the present invention;

FIG. 2 is a flowchart illustrating a basic sequence of operations of the driving status detection device of the presently filed embodiment;

FIG. 3 is a flowchart illustrating a basic sequence of operations of a driving status detection device of a second embodiment according to the present invention;

FIG. 4 is a block diagram illustrating a structure of a driving status detection device of a third embodiment according to the present invention;

FIG. 5 is a flowchart illustrating a basic sequence of operations of the driving status detection device of the presently filed embodiment;

FIG. 6 is a flowchart continuing from steps in FIG. 5;

FIG. 7 is a block diagram illustrating a structure of a driving status detection device of a fourth embodiment according to the present invention;

FIG. 8 is a view illustrating one example of distraction database of the presently filed embodiment;

FIG. 9 is a flowchart illustrating a basic sequence of operations of the driving status detection device of the presently filed embodiment;

FIG. 10 is a flowchart illustrating a basic sequence of operations of the driving status detection device of the presently filed embodiment;

FIG. 11 is a view illustrating one example of distraction database of a fifth embodiment according to the present invention;

FIG. 12 is a flowchart illustrating a basic sequence of operations of the driving status detection device of the presently filed embodiment;

FIG. 13 is a flowchart illustrating a basic sequence of operations of the driving status detection device of the presently filed embodiment;

FIG. 14 is a block diagram illustrating a structure of a driving status detection device of a sixth embodiment according to the present invention;

FIG. 15 is a view illustrating one example of a difficult running direction database of the presently filed embodiment;

FIG. 16 is a flowchart illustrating a basic sequence of operations of the driving status detection device of the presently filed embodiment;

FIG. 17 is a flowchart illustrating a basic sequence of operations of the driving status detection device of the presently filed embodiment;

FIG. 18 is a block diagram illustrating a structure of a driving status detection device of a seventh embodiment according to the present invention;

FIG. 19 is a view illustrating a classification of a driving status of the presently filed embodiment;

FIG. 20 is an illustrative view showing the classification of the driving status of the presently filed embodiment;

FIG. 21 is a view illustrating one example of a difficult driving status database of the presently filed embodiment;

FIG. 22 is a flowchart illustrating a basic sequence of operations of the driving status detection device of the presently filed embodiment;

FIG. 23 is a block diagram illustrating a structure of a driving status detection device of an eighth embodiment according to the present invention;

FIG. 24 is a flowchart illustrating a basic sequence of operations of the driving status detection device of the presently filed embodiment;

FIG. 25 is a view illustrating electronic map data stored in an electronic map database of the driving status detection device of the presently filed embodiment;

FIG. 26 is a view illustrating one example of risk occurrence scene data stored in the risk occurrence scene database of the driving status detection device of the presently filed embodiment;

FIG. 27 is a view illustrating one example of electronic map data stored in an electronic map database of a driving status detection device of a ninth embodiment;

FIG. 28 is a view illustrating one example of risk occurrence scene data stored in the risk occurrence scene database of the driving status detection device of the presently filed embodiment;

FIG. 29 is a block diagram illustrating a structure of a driving status detection device of a tenth embodiment according to the present invention;

FIG. 30 is a flowchart illustrating a basic sequence of operations of the driving status detection device of the presently filed embodiment

### DETAILED DESCRIPTION OF THE PREFERRED EMBODIMENTS

Hereinafter, driving status detection devices and related methods of various embodiments according to the present invention are described in detail with suitable reference to the accompanying drawings.

### First Embodiment

First, detailed description is made of a driving status detection device and its related method of a first embodiment according to the present invention.

With the presently filed embodiment, under circumstances where a jerk conversion value, resulting from a so-called jerk value related to a vehicle speed, exceeds a reference range, it is contemplated to detect distraction of a driver, forming one of risk occurrence scenes of a driver, that is, a status of a driver in which his attention is diminished with less concentration on his driving operation.

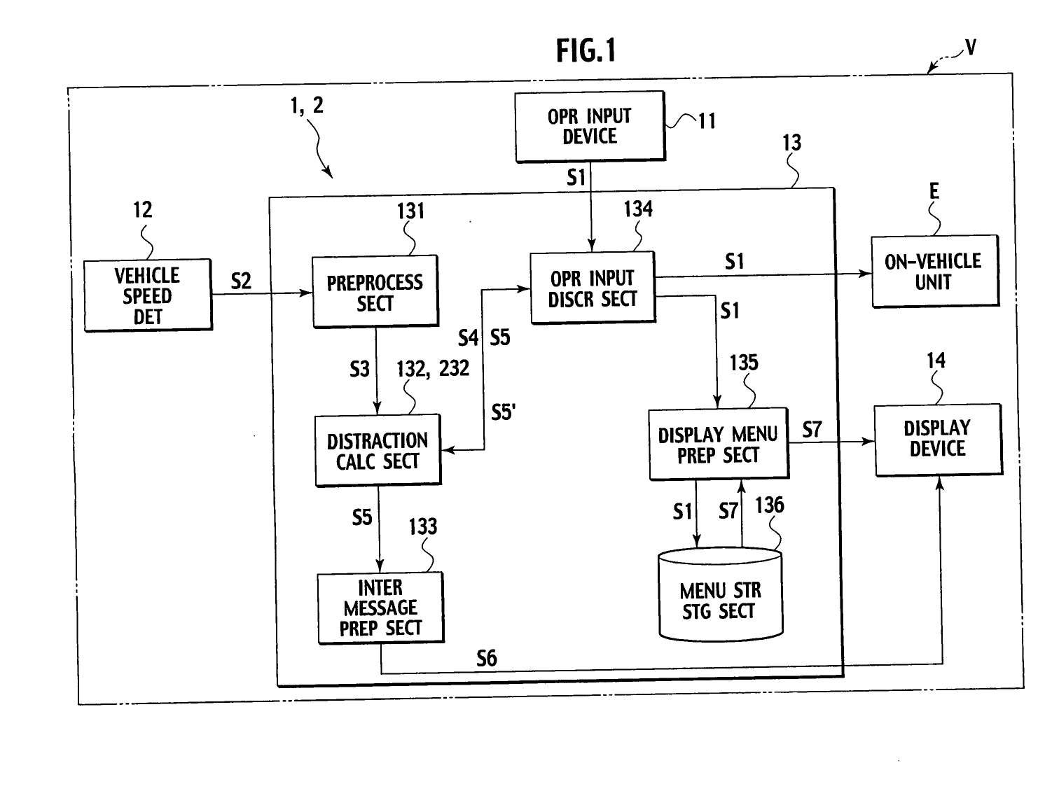

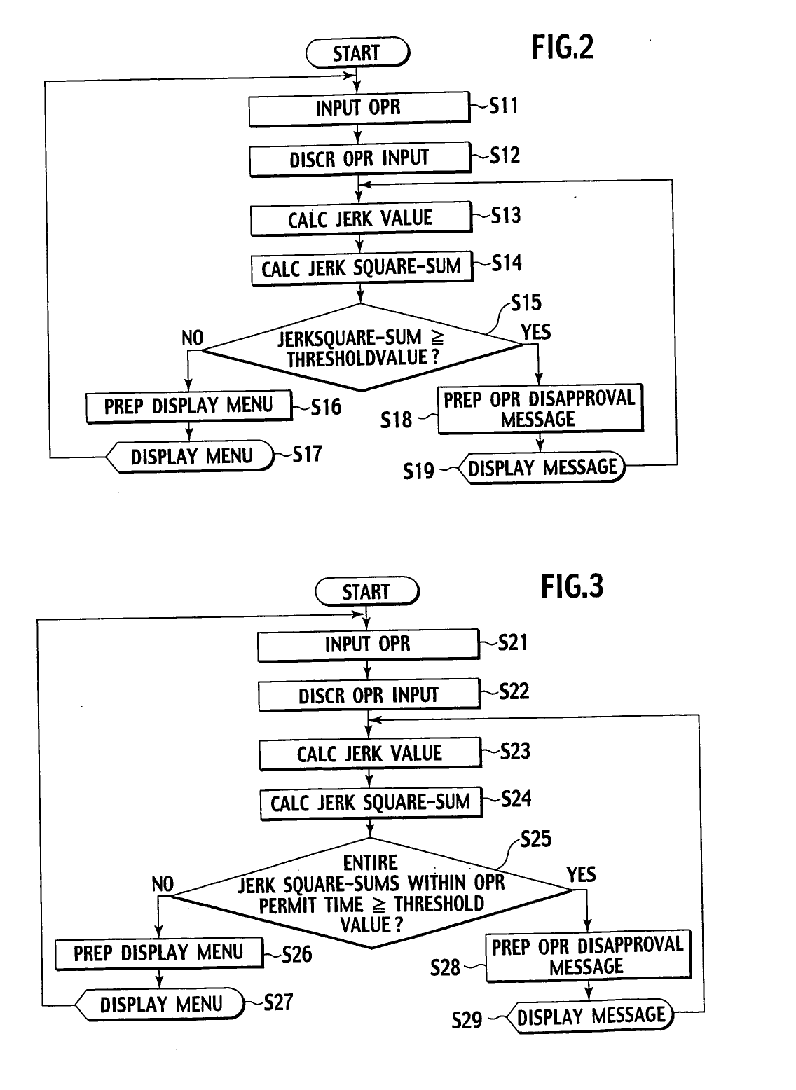

Hereunder, referring to FIGS. 1 and 2, the driving status detection device is described below in detail.

FIG. 1 is a block diagram showing an overall structure of the driving status detection device of the presently filed embodiment, and FIG. 2 is a flowchart showing a basic sequence of operations of the driving status detection device of the presently filed embodiment.

As shown in FIG. 1, the driving status detection device 1 is comprised of an operation input device 11, a vehicle speed detector 12, an on-vehicle computer 13, a display device 14, all of which are mounted on a vehicle V on which a variety of on-vehicle units E are installed. Further, the on-vehicle computer 13 includes a preprocessing section 131, a distraction calculating section 132, an interrupt message preparing section 133, an operation input discriminating section 134 that specifies on-vehicle units to be operated and disables their operations, a display-menu preparing section 135 and a menu structure storage section 136.

The operation input device 11 is used by a vehicle driver to operate on-vehicle units and, depending on driver's operation, generates an operation signal S1 related to the operation of the on-vehicle unit. The operation input device 11 outputs the generated operation signal to the on-vehicle computer 13. Also, the operation input device 11 includes a joystick, a jog dial and push buttons of a mobile phone.

The vehicle speed detector 12 detects a vehicle speed to generate a vehicle speed signal S2 indicative of a detected vehicle speed. The resulting speed signal is outputted to the on-vehicle computer 13. Also, the vehicle speed detector 12 includes a vehicle-wheel speed sensor.

The preprocessing section 131 calculates a jerk value of the vehicle depending on the vehicle speed delivered from the vehicle speed detector 12. Here, the jerk value “J” is expressed by a formula, described below, wherein “v” represents a vehicle speed and “a” represents acceleration of a vehicle and designates a differentiated value of first order in terms of time in acceleration while indicating a differentiated value of second order in terms of time in speed.
J=da/dt=d²v/dt²

Then, the preprocessing section 131 calculates an integrated value (hereinafter referred to as jerk square-sum) of a square of the jerk value. Here, the jerk square-sum SJ (tn) at certain time tn is obtained by integrating the square J2 of the jerk value from time t (n−m) to time (n+m) wherein (n, m are positive integers) and expressed by a formula described below.

$$\begin{matrix}SJ ( tn ) = {J}^{2} ( t ( n - m ) ) + {J}^{2} ( t ( n - m + 1 ) ) + … + {J}^{2} ( t ( n + m ) ) \\ = Σ {J}^{2} ( t = t ( n - m ) … t ( n + m ) )\end{matrix}$$

The preprocessing section 131 generates a jerk square-sum signal S3, related to a calculated jerk square-sum, which is outputted to the distraction calculating section 132.

The distraction calculating section 132 sets a reference value (threshold value) corresponding to the operation executed by the driver on the on-vehicle unit depending on a vehicle unit detection signal S4. Also, the distraction calculating section 132 sets a reference value such that the higher the difficulty for the operation of the on-vehicle unit, the smaller will be the reference value, and a range, less than the reference value, becomes a reference value.

The distraction calculating section 132 compares the jerk square-sum signal to the reference value based on the jerk square-sum signal delivered from the preprocessing section 131. As a result, upon calculation in that the jerk square-sum signal exceeds the reference value, the distraction calculating section 132 detects the occurrence of distraction encountered by the driver. The distraction calculating section 132 generates an operation-disabling signal S5 that is outputted to the interrupt message preparing section 133 and the operation input discriminating section 134. On the contrary, if the calculation result reveals that the jerk square-sum signal is less than the reference value, the distraction calculating section 132 detects that no distraction occurs on the driver and generates an operation permit signal S5′ that is outputted to the operation input discriminating section 134.

The interrupt message preparing section 133 generates an interrupt data signal, raising awareness to the driver to interrupt the operation of the on-vehicle unit in response to the operation-disabling signal delivered from the distraction calculating section 132.

The operation input discriminating section 134 detects the presence of or the absence of the operation conducted by the driver or the on-vehicle unit, which is an object to be operated by the driver, in response to the operation signal delivered from the operation input device 11. The operation input discriminating section 134 generates an on-vehicle unit detection signal S4, related to detected operation and relevant on-vehicle unit, which are outputted to the distraction calculating section 132.

Upon receipt of the operation-disabling signal from the distraction calculating section 132, the operation input discriminating section 134 clears out the operation signal delivered from the operation input device 11. On the contrary, upon receipt of the operation permit signal from the distraction calculating section 132, the operation signal S1 is outputted to the display-menu preparing section 135 and the on-vehicle unit E associated with the operation signal.

Accordingly, the driving status detecting device 1 inhibits the operation of the on-vehicle unit under a situation wherein the jerk square-sum signal exceeds the reference value and, under a situation wherein the jerk square-sum signal is less than the reference value, the operation of the on-vehicle unit is permitted. Therefore, with the operation of the on-vehicle unit permitted, operating the operation input device 11 enables the driver to operate the on-vehicle unit.

Here, such an operation is enabled for reasons described below.

That is, the jerk value is a differentiated value of a second order of the vehicle speed, e.g., a rate of change per unit time of acceleration, and as an accelerator pedal moves, the acceleration naturally varies such that the higher the frequency of actuations of the accelerator pedal and actuation speed, the larger will be the jerk square-sum.

The lower the consciousness for the accelerator pedal operation due to the occurrence of diminished attention of the driver, the greater will be the variation in the operation of the accelerator pedal with a resultant increase in the frequency of operations of the accelerator pedal and an increase in the actuating speed, resulting in an increase in the jerk square-sum.

Accordingly, the jerk square-sum, resulting from the occurrence in the driver distraction, becomes larger than that in the absence of the driver distraction. Thus, the driving status detection device 1 has a structure wherein a reference value, associated with the jerk square-sum, is set to enable the driver distraction to be detected when the jerk square-sum exceeds the reference value.

Further, the reference value, with respect to the jerk square-sum, is set such that the higher the degree of difficulty in operation of the on-vehicle unit, the smaller will be the jerk square-sum for the reasons described below.

That is, as the degree of difficulty in operation executed by the driver increases, driver's attention is scattered with an increased probability of causing distraction. Consequently, as the degree of difficulty in operation executed by the driver increases, the driving status detection device 1 needs to detect the driver distraction in an early stage. To this end, the driving status detection device 1 is configured to have a structure in that the higher the degree of difficulty in operation, the smaller will be the reference value.

The display-menu preparing section 135 acquires a display menu data signal S7, associated with a content of the operation signal delivered from the operation input discriminating section 134, from the menu structure storage section 136, which will be described below, and outputs the same to the display device 14.

The menu structure storage section 136 stores a variety of display menu data and outputs the display menu data signal S7, associated with the operation signal inputted via the display-menu preparing section 135, to the display-menu preparing section 135.

The display device 14 provides a display of a content of the interrupt data signal, delivered from the interrupt message preparing section 133, and a content of display menu data signal, delivered from the display-menu preparing section 135, over a screen.

Now, a basic sequence of operations of the driving status detection device 1 is described in detail with reference to FIG. 2. Such a sequence of operations is typically commenced upon turning on a vehicle ignition key and terminated upon turning off the ignition key.

As shown in FIG. 2, the sequence starts and if the driver operates the operation input device 11 in step S11, the operation input device 11 generates an operation signal associated with the operation of the on-vehicle unit depending on such operation. Next, the operation input device 11 outputs the resulting operation signal to the on-vehicle computer 13.

In consecutively step S12, the operation input discriminating section 134 generates an on-vehicle unit detection signal, in response to the operation signal delivered from the operation input device 11, which in turn is outputted to the distraction calculating section 132.

In subsequently step S13, the vehicle speed detector 12 detects a vehicle speed to generate a speed signal related to the detected vehicle speed. Next, the vehicle speed detector 12 outputs the resulting speed signal to the on-vehicle computer 13 and the preprocessing section 131 calculates a jerk value of the vehicle based on the speed signal delivered from the vehicle speed detector 12.

Then, in step S14, the preprocessing section 131 calculates a jerk square-sum based on the calculated jerk value. Consecutively, the preprocessing section 131 generates a jerk square-sum signal, related to the calculated jerk square-sum, which in turn is outputted to the distraction calculating section 132.

Next, in step S15, the distraction calculating section 132 sets a reference value, associated with the operation executed on the on-vehicle unit by the driver, in response to the on-vehicle unit detection signal delivered from the operation input discriminating section 134.

Subsequently, the distraction calculating section 132 makes comparison between the jerk square-sum and the reference value, which is set, depending on the jerk square-sum signal delivered from the preprocessing section 131. As a result, the distraction calculating section 132 detects the occurrence of the driver distraction when the jerk square-sum signal exceeds the reference value. Thereafter, the operation proceeds to step S18. In contrast, if jerk square-sum signal becomes less than the reference value (with NO in step S15), the operation proceeds to step S16.

With the operation routed to step S16, the distraction calculating section 132 generates an operation permit signal that is outputted to the operation input discriminating section 134. Then, the operation input discriminating section 134 outputs the operation signal, delivered from the operation input device 11, to the display-menu preparing section 135 and the on-vehicle unit associated with the operation signal. Then, the on-vehicle unit executes the operation depending on the content of the operation signal delivered from the operation input discriminating section 134. This enables the driver to operate the on-vehicle unit using the operation input device 11.

Further, the display-menu preparing section 135 acquires the display menu data signal, associated with the operation signal delivered from the operation input discriminating section 134, from the menu structure storage section 136 and outputs the same to the display device 14.

In subsequently step S17, the display device 14 provides a display of the content of the display menu data signal, delivered from the display-menu preparing section 135, over the screen. This enables the driver to continuously operate the on-vehicle unit based on the display menu displayed over the display device 14. Thereafter, the operation proceeds to step S11 for repeated execution of the series of operations.

In the meanwhile, if the operation proceeds to step S18, the distraction calculating section 132 generates an operation-disabling signal that in turn is outputted to the interrupt message preparing section 133 and the operation input discriminating section 134. Consecutively, the operation input discriminating section 134 clears out the operation signal delivered from the operation input device 11. This disables the operation of the on-vehicle unit depending on the operation executed by the driver, thereby disabling the operation of the on-vehicle unit.

Further, the interrupt message preparing section 133 generates an interrupt data signal, raising awareness to the driver to interrupt the operation of the on-vehicle unit, in response to the operation-disabling signal delivered from the distraction calculating section 132, thereby outputting the same to the display device 14.

In succeeding step S19, the display device 14 provides a display of content of the interrupt data signal delivered from the interrupt message preparing section 133 over the screen. Thereafter, the operation is routed back to step S13 for repeated execution of the series of operations.

With the presently filed embodiment, as set forth above, the driving status detection device 1 detects the driver distraction when the jerk square-sum exceeds the reference value. In the meanwhile, the jerk square-sum, resulting from the occurrence of the driver distraction, becomes larger than the jerk square-sum in the absence of the driver distraction. Accordingly, by performing such operations, the driving status detection device 1 is able to reliably detect the driver distraction.

Further, upon detection of the driver distraction, since the driving status detection device 1 provides a display of content of the interrupt data signal over the screen raising awareness to the driver to interrupt the operation of the on-vehicle unit, it becomes possible to raise awareness to the driver to interrupt the operation of the on-vehicle unit.

Furthermore, since when the driver distraction is detected, the driving status detection device 1 inhibits the operation of the on-vehicle unit, it becomes possible to urge the driver to stop the operation of the on-vehicle unit. This enables the driving status detection device 1 to reliably eliminate the driver distraction.

Additionally, since the driving status detection device 1 calculates the jerk value when the driver operates the on-vehicle unit, it is possible to reliably detect the distraction resulting from the operation of the on-vehicle unit executed by the driver.

Moreover, the driving status detection device 1 is arranged to calculate the jerk value square-sum as a jerk conversion value and, thus, the driver distraction can be reliably detected. Even if less variation exists in the operation of the accelerator pedal at each point of time, the presence of variation in a continuous phase results in an increase in the jerk square-sum, enabling the driving status detection device 1 to reliably detect the driver distraction.

### Second Embodiment

Next, a driving status detection device and its related method of a second embodiment according to the present invention are described in detail with reference to FIGS. 1 and 3.

FIG. 3 is a flowchart illustrating a basic sequence of operations of the driving status detection device of the presently filed embodiment.

Although the driving status detection device 2 of the presently filed embodiment is described with respect to FIGS. 1 and 3 for the sake of convenience, the driving status detection device 2 mainly differs from that of the first embodiment in that a difference exists in a content of operations in a distraction calculating section 232. Hereunder, with attention focused on such a difference, the same component parts bear like reference numerals and description is suitably omitted or description is made in a simplified form.

As shown in FIG. 1 as a matter of convenience, the distraction calculating section 232 of the driving status detection device 2 sets a reference value, associated with the operation of the on-vehicle unit executed by the driver, based on the on-vehicle unit detection signal delivered from the operation input discriminating section 134. Also, the distraction calculating section 232 determines the reference value such that the higher the degree of difficulty in operation of the on-vehicle unit, the smaller will be the reference value.

The distraction calculating section 232 makes comparison between the jerk square-sum and the reference value, which is settled, based on the jerk square-sum signal delivered from the preprocessing section 131. As a result, the driver distraction is detected when the jerk square-sum signals exceed the reference value.

After the driver distraction has been detected, the distraction calculating section 232 makes comparison between the jerk square-sum, within an operation permit time interval, and the reference value based on a plurality of jerk square-sum signals delivered from the preprocessing section 131 within the operation permit time interval. As a result, if all of the jerk square-sum signals within the operation permit time interval exceed the reference value, the distraction calculating section 232 generates an operation-disabling signal that is outputted to the interrupt message preparing section 133 and the operation input discriminating section 134.

In the meanwhile, if no driver distraction is detected by the distraction calculating section 232, or if any of the jerk square-sum signals is less than the reference value, the distraction calculating section 232 generates an operation permit signal that is outputted to the operation input discriminating section 134. Accordingly, the driving status detection device 2 allows the content of the interrupt data signal to be displayed over the screen, under a situation in which all of the jerk square-sum signals exceed the reference value within the operation permit time interval after the driver distraction has been detected, and disables the operation of the on-vehicle unit. Also, the operation permit time interval is set to a value of 30 (s).

Now, a basic sequence of operations of the driving status detection device 2 is described with respect to FIG. 3.

The operations in step S21 to S24, shown in FIG. 3, are similar to those of steps S11 to S14, shown in FIG. 2, related to the first embodiment.

Next in step S25, the distraction calculating section 232 sets a reference value, associated with the operation of the on-vehicle unit executed by the driver, in response to the on-vehicle unit detection signal delivered from the operation input discriminating section 134. Subsequently, the distraction calculating section 232 makes comparison between the jerk square-sum and the reference value, which is settled, depending on the jerk square-sum signal delivered from the preprocessing section 131. As a result, the distraction calculating section 232 detects the occurrence of the driver distraction when the jerk square-sum exceeds the reference value,

Here, under circumstances where the distraction calculating section 232 detects the driver distraction, the operations in step S21 to step S24 are repeatedly executed for the operation permit time interval.

If the distraction calculating section 232 discriminates that the operation permit time interval has elapsed, the distraction calculating section 232 makes comparison between the jerk square-sum and the reference value based on the plurality of jerk square-sum signals delivered from the preprocessing section 131 within the operation permit time interval. As a result, if the entire jerk square-sum signals within the operation permit time interval exceed the reference value, the operation proceeds to step S28. The operations in step S28 to S29 are similar to those of steps S18 to S19 of the first embodiment shown in FIG. 2.

On the contrary, if the distraction calculating section 232 does not detect the driver distraction from the start, or, if any of the jerk square-sum signals within the operation permit time interval becomes less than the reference value, the operation proceeds to step S26. The operations in step S26 to S27 are similar to those of steps S16 to S17 of the first embodiment shown in FIG. 2.

With the presently filed embodiment, as set forth above, the driving status detection device 2 detects the driver distraction and, thereafter, under circumstances where the jerk square-sum signals within the operation permit time interval exceeds the reference value, provides a display of content of the interrupt data signal over the screen while inhibiting the operation of the on-vehicle unit.

Accordingly, after the driver distraction has been detected, since the driving status detection device 2 is enabled to provide a display of content of the interrupt data signal over the screen while disabling the operation of the on-vehicle unit upon the elapse of the operation permit time interval, the frequent occurrence of inhibitions in the on-vehicle unit can be prevented. Therefore, the driving status detection device 2 is able to preclude the driver from botheration.

### Third Embodiment

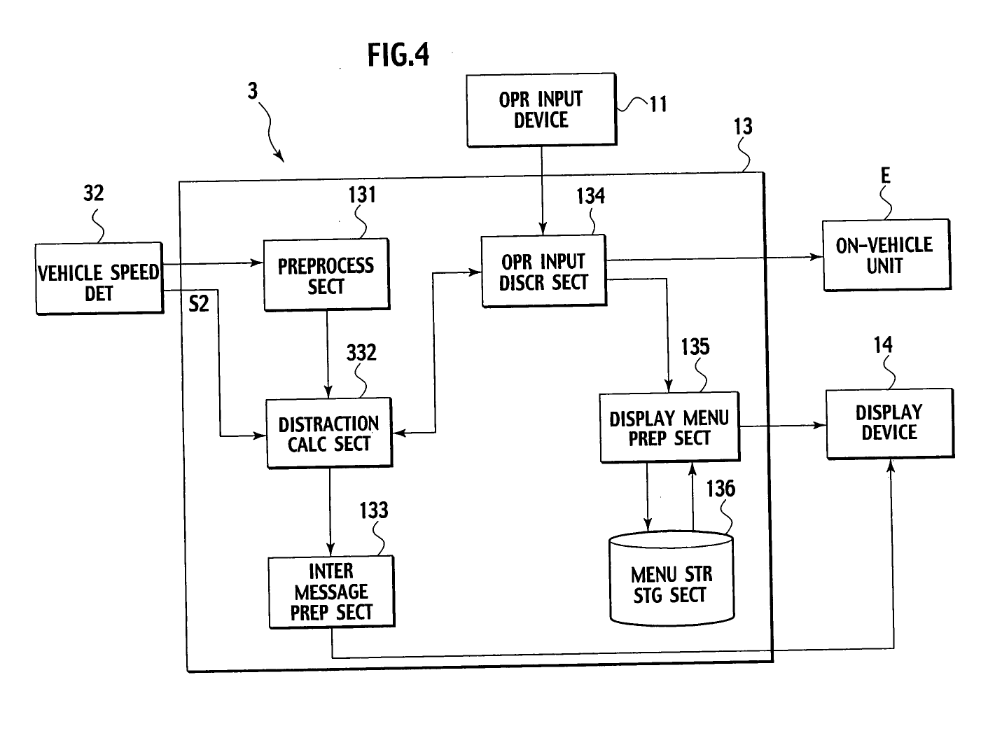

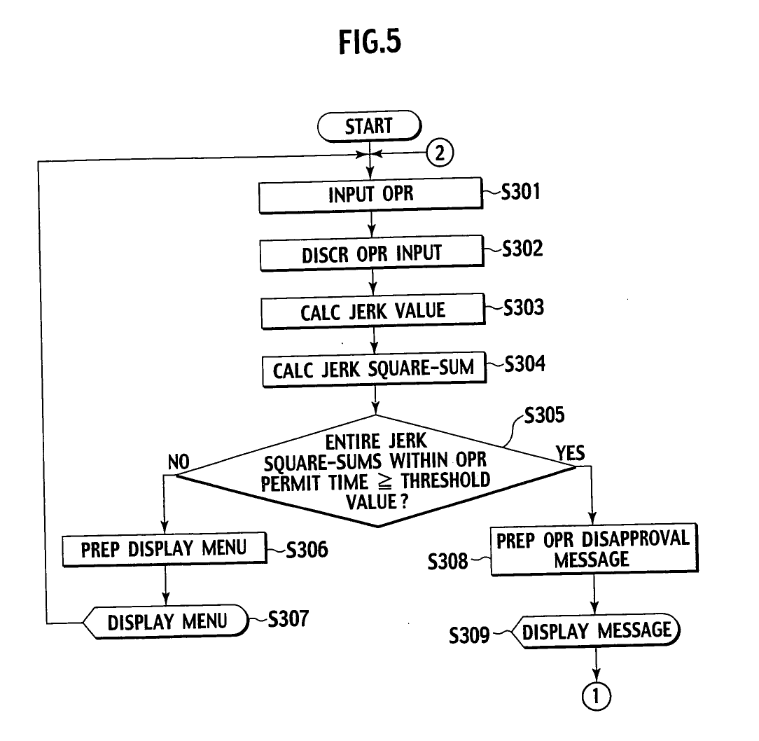

Next, a driving status detection device and its related method of a third embodiment according to the present invention are described in detail with reference to FIGS. 4 to 6.

Although the driving status detection device 3 of the presently filed embodiment mainly differs from that of the second embodiment in respect of a difference in content of operations of a distraction calculating section 332. Hereunder, with attention focused on such a difference, the same component parts bear like reference numerals and description is suitably omitted or description is made in a simplified form.

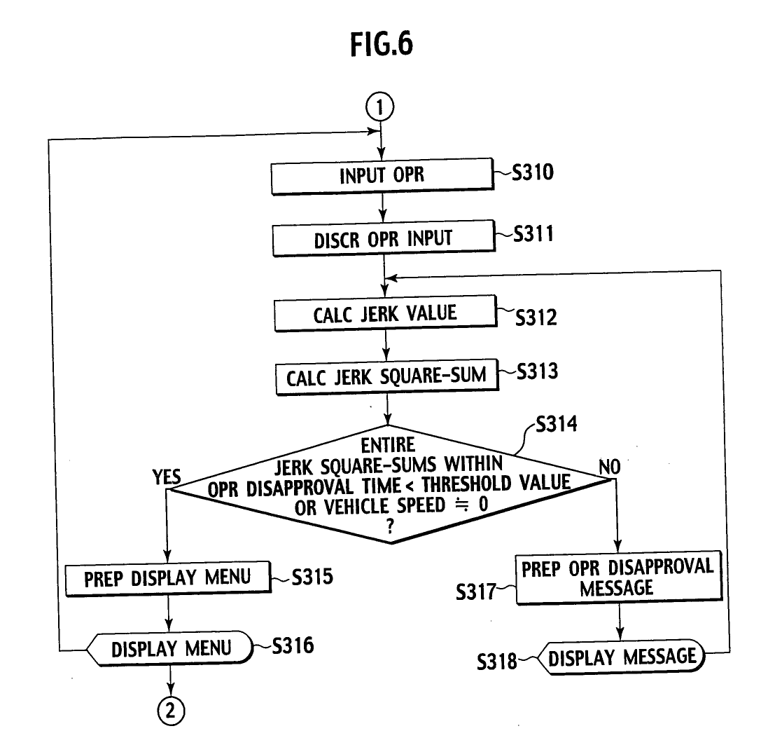

FIG. 4 is a block diagram illustrating the structure of the driving status detection device 3 of the presently filed embodiment; FIG. 5 is a flowchart illustrating a basic sequence of operations of the driving status detection device of the presently filed embodiment; and FIG. 6 is a flowchart illustrating operations continuing from those of FIG. 5.

As shown in FIG. 4, the vehicle speed detector 32 detects the vehicle speed and generates a vehicle speed signal related to the detected vehicle speed. The resulting speed signal is outputted to the preprocessing section 131 and the distraction calculating section 332. Also, the vehicle speed detector 32 may include a vehicle-wheel speed sensor.

The distraction calculating section 332 sets a reference value, associated with the operations of the on-vehicle unit executed by the driver, based on the on-vehicle unit detection signal delivered from the operation input discriminating section 134. Also, the distraction calculating section 332 sets the reference value such that the higher the degree of difficulty in operation of the on-vehicle unit, the smaller will be the reference value.

The distraction calculating section 332 makes comparison between the jerk square-sum signal and the reference value, which is settled, based on the jerk square-sum signal delivered from the preprocessing section 131. As a result, the driver distraction is detected when the jerk square-sum exceeds the reference value.

After the driver distraction has been detected, the distraction calculating section 332 makes comparison between the jerk square-sum, within an operation permit time interval, and the reference value based on a plurality of jerk square-sum signals delivered from the preprocessing section 131 within the operation permit time interval. As a result, when the entire jerk square-sum signals within the operation permit time interval exceed the reference value, the distraction calculating section 332 generates an operation-disabling signal that is outputted to the interrupt message preparing section 133 and the operation input discriminating section 134.

In contrast, if the distraction calculating section 332 does not detect the driver distraction, or if any of the jerk square-sum signals, within the operation permit time interval, is less than the reference value, the distraction calculating section 332 generates an operation permit signal that is outputted to the operation input discriminating section 134. Accordingly, after the driver distraction has been detected, the driving status detection device 3 allows the content of the interrupt data signal to be displayed over the screen, under a situation in which the entire jerk square-sum signals exceed the reference value within the operation permit time interval, and inhibits the operation of the on-vehicle unit.

Further, after the operation of the on-vehicle unit is inhibited, the distraction calculating section 332 sets a reference value, associated with the operation of the on-vehicle unit executed by the driver, based on the on-vehicle unit detection signal delivered from the operation input discriminating section 134. Also, the distraction calculating section 332 sets the reference value such that the higher the degree of difficulty in operation of the on-vehicle unit, the smaller will be the reference value.

The distraction calculating section 332 discriminates whether the vehicle stands halt in response to the speed signal delivered from the vehicle speed detector 32. As a result, when the vehicle stands halt, the distraction calculating section 332 generates an operation permit signal, which in turn is outputted to the operation input discriminating section 134.

In the meanwhile, if the vehicle is not halted (that is, during running), the distraction calculating section 332 makes comparison between the jerk square-sum, within an operation disabling time interval, and the reference value based on a plurality of jerk square-sum signals delivered from the preprocessing section 131 within the operation disabling time interval. As a result, when the entire jerk square-sum signals within the operation disabling time interval exceed the reference value, the distraction calculating section 332 generates an operation permit signal that is outputted to the operation input discriminating section 134. In contrast, if at least one of the jerk square-sum signals within the operation disabling time interval exceed the reference value, the distraction calculating section 332 generates an operation-disabling signal that is outputted to the interrupt message preparing section 133 and the operation input discriminating section 134.

Accordingly, after the operation of the on-vehicle unit has been disabled, the operation of the on-vehicle unit is permitted under circumstances where the vehicle stands halt or the whole jerk square-sum signals, within the operation disabling time interval, are less than the reference value. Also, the operation disabling time interval may be set to a value of 30 (s).

Now, a basic sequence of operations of the driving status detection device 3 is described with respect to FIGS. 5 and 6.

The driving status detection device 3 executes operations in steps S301 to S309, shown in FIG. 5, in the same manner as those of steps S21 to S29 shown in FIG. 3.

After the operation in step S309 has been executed in the driving status detection device 3, if the driver operates the operation input device 11 in step S310 shown in FIG. 6, the operation input device 11 generates an operation signal, related to the operation of the on-vehicle unit, depending on such operation. Then, the operation input device 11 outputs the resulting operation signal to the on-vehicle computer 13.

In subsequent step S311, the operation input discriminating section 134 generates an on-vehicle unit detection signal, depending on the operation signal delivered from the operation input device 11, which in turn is outputted to the distraction calculating section 332.

In consecutive step S312, the vehicle speed detector 32 detects the vehicle speed to generate a speed signal related to the detected vehicle speed. Next, the vehicle speed detector 32 outputs the resulting speed signal to the on-vehicle unit computer 13 and the preprocessing section 131 calculates a jerk value of the vehicle depending on the speed signal delivered from the vehicle speed detector 32.

Then, in step S313, the preprocessing section 131 calculates a jerk square-sum based on a calculated jerk value. Then, the preprocessing section 131 generates a jerk square-sum signal, related to the calculated jerk square-sum, which in turn is outputted to the distraction calculating section 332.

Next in step S314, the distraction calculating section 332 sets a reference value, associated with the operation of the on-vehicle unit executed by the driver, in response to the on-vehicle unit detection signal delivered from the operation input discriminating section 134.

Additionally, the distraction calculating section 332 discriminates whether the vehicle stands halt in response to the vehicle speed signal delivered from the vehicle speed detector 32. As a result, when the vehicle stands halt, the operation proceeds to step S315.

In contrast, if the vehicle does not stand halt (that is, during running), the driving status detection device 3 repeatedly executes the operations in steps S310 to S313 during the operation disabling time interval and the distraction calculating section 332 makes comparison between the jerk square-sum, within an operation disabling time interval, and the reference value based on a plurality of jerk square-sum signals delivered from the preprocessing section 131 within the operation disabling time interval. As a result, if the whole jerk square-sum signals within the operation disabling time interval are less than the reference value, the driving status detection device 3 allows the operation to proceed to step S315 and, if at least one of the jerk square-sum within the operation disabling time interval exceeds the reference value, the operation proceeds to step S317.

If the operation proceeds to step S315, then, the distraction calculating section 332 generates an operation permit signal, which in turn is outputted to the operation input discriminating section 134. Consecutively, the operation input discriminating section 134 outputs the operation signal, delivered from the operation input device 11, to the display-menu preparing section 135 and the on-vehicle unit associated with such operation signal. Subsequently, the on-vehicle unit executes the operation depending on the content of the operation signal delivered from the operation input discriminating section 134. This enables the driver to operate the on-vehicle unit using the operation input device 11.

Additionally, the display-menu preparing section 135 acquires the display menu data signal, associated with the operation signal delivered from the operation input discriminating section 134, from the menu structure storage section 136, and outputs the same to the display device 14.

Next, in step S316, the display device 14 provides a display of the display menu data signal, delivered from the display-menu preparing section 135, over the screen. This enables the driver to continuously operate the on-vehicle unit depending on the display menu displayed over the display device 14. Thereafter, the operation is routed back to step S301 shown in FIG. 5.

In the meanwhile, if the operation proceeds to step S317, the distraction calculating section 332 generates an operation-disabling signal, which in turn is outputted to the interrupt message preparing section 133 and the operation input discriminating section 134. Consecutively, the operation input discriminating section 134 clears out the operation signal delivered from the operation input device 11. This disables the operation of the on-vehicle unit depending on the operation of the driver, thereby disabling the operation of the on-vehicle unit.

Further, the interrupt message preparing section 133 generates an interrupt data signal, raising awareness to the driver to interrupt the operations of the on-vehicle unit, in response to the operation-disabling signal delivered from the distraction calculating section 332 and outputs the same to the display device 14.

In subsequent step S318, the display device 14 provides a display of the content of the interrupt data signal delivered from the interrupt message preparing section 133 over the screen. Thereafter, the operation is routed back to step S312.

With the presently filed embodiment, as set forth above, the driving status detection device 3 permits the operation of the on-vehicle unit under circumstances where, after the operation of the on-vehicle unit is inhibited, the entire jerk square-sums within the operation disabling time interval are less than the reference value.

Accordingly, after the operation of the on-vehicle unit has been disabled, the driving status detection device 3 is able to permit the operation of the on-vehicle unit when the operation disabling time interval elapses after the jerk square-sum becomes less than the reference value. Therefore, after the operation of the on-vehicle unit has been disabled, the driving status detection device 3 is able to prevent the operation of the on-vehicle unit from being frequently permitted, thereby enabling the driver from botheration.

In particular, after the operation of the on-vehicle unit has been permitted, the driving status detection device 3 performs the same operations as those of the driving status detection device 2 of the second embodiment. Thus, once the operation of the on-vehicle unit has been disabled, the operation of the on-vehicle unit is inhibited for at least the operation disabling time interval and, once the operation of the on-vehicle unit has been permitted, the operation of the on-vehicle unit is permitted for at least the operation permit time interval. Accordingly, the driving status detection device 3 is enabled to prevent frequent turnover between an operation permit condition and an operation inhibit condition of the on-vehicle unit.

Further, the driving status detection device 3 permit the operation of the on-vehicle unit when the vehicle comes to a halt after the operation of the on-vehicle unit is inhibited. Here, if the vehicle comes to a halt, the driver is able to easily operate the on-vehicle unit.

Consequently, after the operation of the on-vehicle unit has been permitted, the driving status detection device 3 is able to immediately permit the operation of the on-vehicle unit, when the driver is enabled to easily operate the on-vehicle unit, and in this respect, makes it possible to preclude the driver from botheration.

### Fourth Embodiment

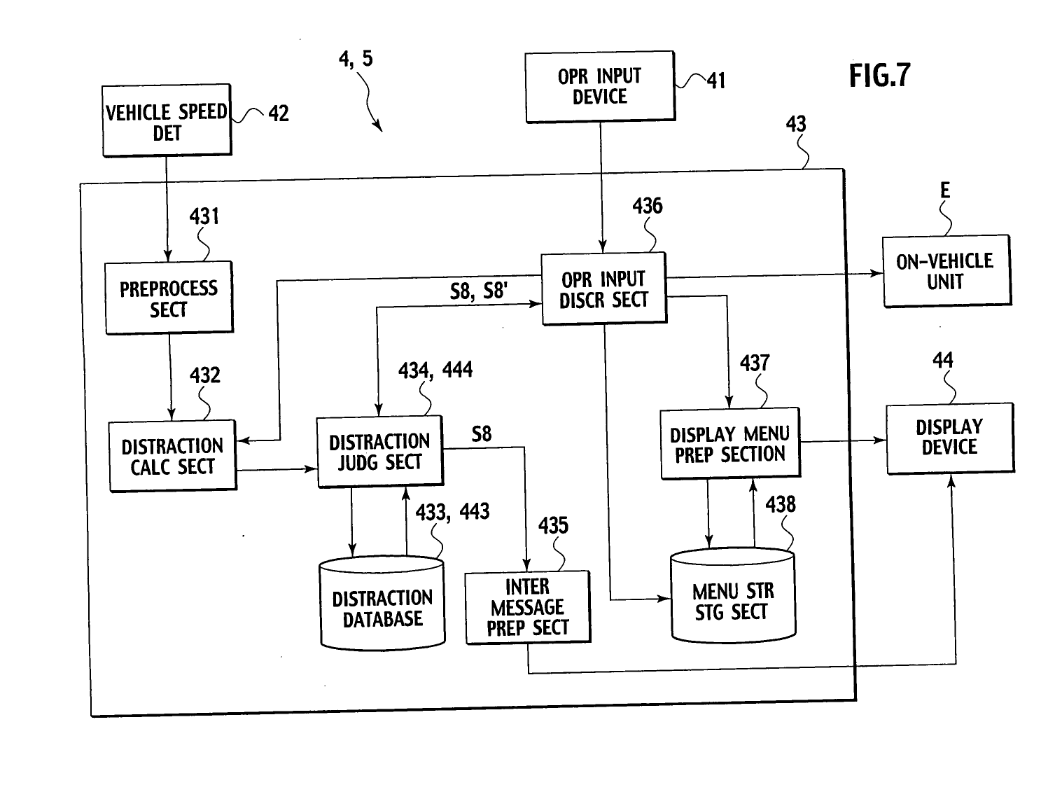

Next, a driving status detection device and its related method of a fourth embodiment according to the present invention are described in detail with reference to FIGS. 7 to 10.

Although the driving status detection device 4 of the presently filed embodiment mainly differs from that of the first embodiment in that a distraction database 433 and a distraction judgment section 434 are additionally provided. Hereunder, with attention focused on such a difference, the same component parts bear like reference numerals and description is suitably omitted or description is made in a simplified form.

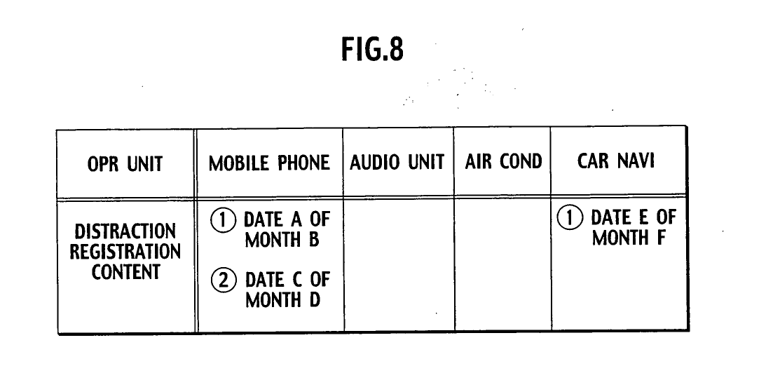

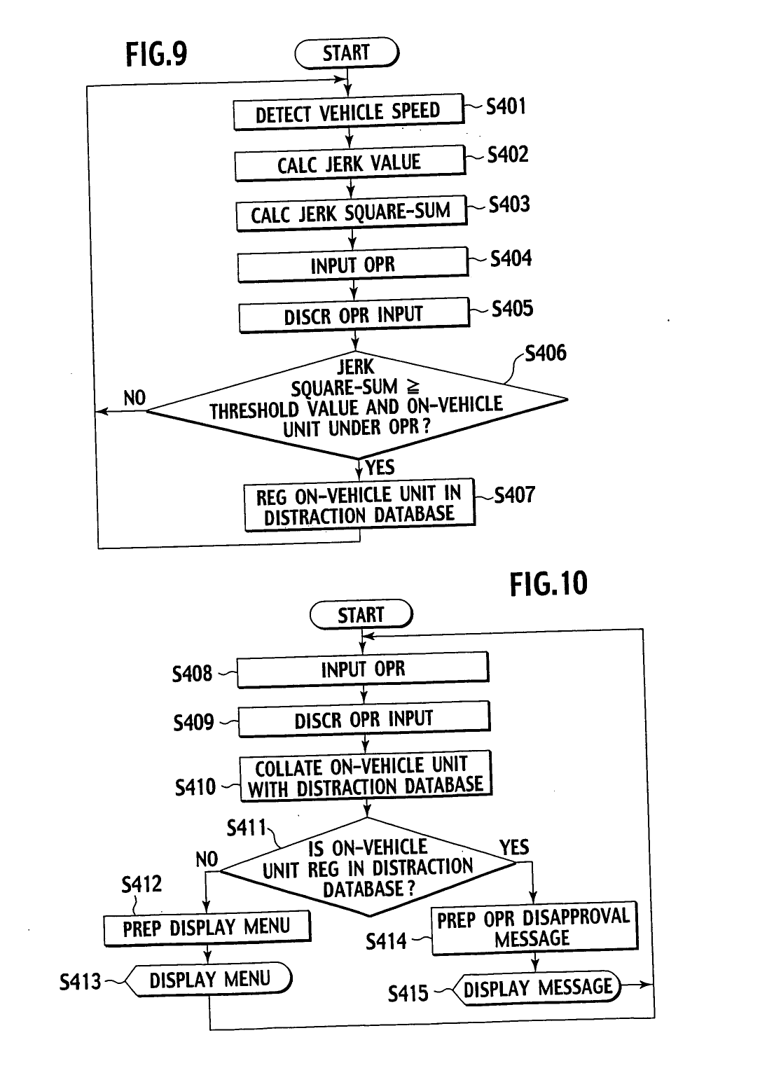

FIG. 7 is a block diagram illustrating a structure of the driving status detection device of the presently filed embodiment; FIG. 8 is a view showing one example of a distraction database of the presently filed embodiment; FIG. 9 is a flowchart illustrating a basic sequence of operations of the driving status detection device of the presently filed embodiment; and FIG. 10 is a flowchart illustrating operations to be executed by the driving status detection device of the presently filed embodiment.

As shown in FIG. 7, the driving status detection device 4 is comprised of an operation input device 41, a vehicle speed detector 42, an on-vehicle computer 43 and a display device 44. The on-vehicle computer 43 is comprised of a preprocessing section 431 that calculates a jerk value and a jerk conversion value, a distraction calculating section 432, a distraction database 433, a distraction judgment section 434 that performs a difficulty detection and registration of the same, an interrupt message preparing section 435, an operation input discriminating section 436 that specifies on-vehicle units to be operated and disables their operations, a display-menu preparing section 437 and a menu structure storage section 438.

In particular, the operation input device 41, the vehicle speed detector 42, the preprocessing section 431 that calculates a jerk value and a jerk conversion value, the distraction calculating section 432, the interrupt message preparing section 435, the operation input discriminating section 436, the display-menu preparing section 437 and the menu structure storage section 438 and the display device 44 fundamentally have the same structures as those of the first embodiment.

That is, the preprocessing section 431 calculates a jerk value of a vehicle based on a speed signal delivered from the vehicle speed detector 42 and calculates a jerk square-sum based on the calculated jerk value. Then, the preprocessing section 431 generates a jerk square-sum signal, related to the calculated jerk square-sum, which in turn is outputted to the distraction calculating section 432.

The distraction calculating section 432 sets a reference value, associated with operation of an on-vehicle unit executed by a driver, based on an on-vehicle unit detection signal delivered from the operation input discriminating section 436. The distraction calculating section 432 makes comparison between the jerk square-sum and the reference value, based on the jerk square-sum signal delivered from the preprocessing section 431.

Here, the distraction calculating section 432 detects driver distraction when the jerk square-sum exceeds the reference value. Then, the distraction calculating section 432 generates a distraction detection signal, which is outputted to the distraction judgment section 434. In contrast, if the jerk square-sum is less than the reference value, the distraction calculating section 432 clears out the jerk square-sum signal delivered from the preprocessing section 431. Then, the distraction calculating section 432 generates a distraction detection signal, which is outputted to the distraction judgment section 434.

The distraction database 433 has a data area for each kind of on-vehicle units, such as a movable phone and an audio unit, as shown in FIG. 8, and on-vehicle unit history data created by the distraction judgment section 434 is registered in each data area containing distraction registration content. Detailed content of on-vehicle unit history data is described below.

The distraction judgment section 434 includes a timer, which is not shown, and executes on-vehicle unit history registering operation and on-vehicle unit history collating operation.

[On-Vehicle Unit History Registering Operation]

Under circumstances where signals are applied from both the distraction calculating section 432 and the operation input discriminating section 436, the distraction judgment section 434 recognizes an on-vehicle unit, which plays a role as an object operated by a driver, based on an on-vehicle unit detection signal delivered from the operation input discriminating section 436.

Then, the distraction judgment section 434 calculates a current date using the timer. Also, the distraction judgment section 434 specifies a data area, associated with the recognized on-vehicle unit, among the data areas of the distraction database 433 and retrieves the newest on-vehicle unit history data based on the specified data area.

Subsequently, the distraction judgment section 434 increments an on-vehicle unit detection frequency, represented by the newest on-vehicle unit history data, by one to calculate the current on-vehicle unit detection frequency.

Consecutively, the distraction judgment section 434 generates the current on-vehicle unit history data, representing the calculated current date and the on-vehicle unit detection frequency and registers these content in the specified data area of the distraction database 433. The newest on-vehicle unit history data, associated with the “mobile phone” provides a date expressed like “Date A of Month B” and the on-vehicle unit detection frequency to be “2”.

In the meanwhile, of the distraction calculating section 432 and the operation input calculating section 436, if a signal of only one of these sections is applied to the distraction judgment section 434, the distraction judgment section 434 clears out such an applied signal.

Accordingly, the date registered in each data area designates the date and month on which driver distraction and the on-vehicle unit, associated with each data area, are detected by both the distraction calculating section 432 and the operation input calculating section 436. Also, the frequency, in which the on-vehicle unit is registered in each data area, indicates the number of times both the distraction calculating section 432 and the operation input calculating section 436 detect both the driver distraction and on-vehicle unit, associated with each data area, during a period from the start of commencing the on-vehicle unit history registering operation to a date and month represented by a date that corresponds to the on-vehicle unit detection frequency.

Accordingly, it can be said that the on-vehicle unit, whose on-vehicle unit history data is registered in the data area, designates an on-vehicle unit which the driver feels difficult to operate. Also, it can be said that the larger the registration frequency of on-vehicle unit history data, the more difficult will be for the driver to operate.

Now, the on-vehicle unit history registering operation is described more in detail in time series with reference to FIG. 9.

As shown in FIG. 9, in step S401, the vehicle speed detector 42 detects a speed of a vehicle and generates a speed signal related to the detected speed of the vehicle. Consecutively, the vehicle speed detector 42 outputs the resulting speed signal to the on-vehicle computer 43.

Next, in step S402, the preprocessing section 431 calculates a jerk value of the vehicle based on the speed signal delivered from the vehicle speed detector 42.

Subsequently, in step S403, the preprocessing section 431 calculates a jerk square-sum based on the calculated jerk value. Then, the preprocessing section 431 generates a jerk square-sum signal, related to the calculated jerk square-sum, which in turn is outputted to the distraction calculating section 432.

In succeeding step S404, under circumstances where a driver operates the operation input device 41, the operation input device 41 generates an operation signal associated to the operation of the on-vehicle unit. Subsequently, the operation input device 41 outputs the resulting operation signal to the on-vehicle computer 43. Thereafter, the driving status detection device 4 allows the operation to proceed to step S405. In contrast, if the driver does not operate the operation input device 41, the driving status detection device 4 allows the operation to proceed to step S405 without generating and outputting the operation signal.

Next, in step S405, under circumstances where the operation signal is delivered from the operation input device 41, the operation input discriminating section 436 generates an on-vehicle unit detection signal, based on such an operation signal, which in turn is outputted to the distraction calculating section 432 and the distraction judgment section 434. Thereafter, the driving status detection device 4 allows the operation to proceed to step S406. On the contrary, if no operation signal is applied to the operation input discriminating section 436 from the operation input device 41, the driving status detection device 4 allows the operation to proceed to step S406 without generating and outputting the on-vehicle unit detection signal.

Consecutively, in step S406, upon receipt of the on-vehicle unit detection signal delivered from the operation input discriminating section 436, the distraction calculating section 432 sets a reference value, associated with the operation of the on-vehicle unit executed by the driver, based on the on-vehicle unit detection signal.

Additionally, the distraction calculating section 432 makes comparison between the jerk square-sum and the settled reference value based on the jerk square-sum signal delivered from the preprocessing section 431.

As a result, the distraction calculating section 432 detects driver distraction when the jerk square-sum exceeds the reference value. Consecutively, the distraction calculating section 432 generates a distraction detection signal, which in turn is outputted to the distraction judgment section 434.

In contrast, if no on-vehicle unit detection signal is applied to the distraction calculating section 432 or if the jerk square-sum is less than the reference value, the distraction calculating section 432 generates no distraction detection signal.

Further, the distraction judgment section 434 discriminates whether the signals are applied from both the distraction calculating section 432 and the operation input discriminating section 436. As a result, if both the signals are applied, the operation proceeds to step S407. On the contrary, with the signal applied from only one of the distraction calculating section 432 and the operation input discriminating section 436 (with NO in step S406), the distraction judgment section 434 clears out the applied signal. Thereafter, the operation is routed back to step S401.

With the operation routed to step S407, the distraction judgment section 434 recognizes the on-vehicle unit, which the driver operates, based on the on-vehicle unit detection signal delivered from the operation input discriminating section 436.

The distraction judgment section 434 calculates the current date using the timer. Also, the distraction judgment section 434 specifies a data area, associated with the recognized on-vehicle unit, from the data areas of the distraction database 433 to allow the newest on-vehicle unit history data to be retrieved from the specified data area.

In addition, the distraction judgment section 434 increments an on-vehicle unit detection frequency, indicated by the retrieved newest on-vehicle unit history data, by one, thereby calculating the current on-vehicle unit detection frequency.

Subsequently, the distraction judgment section 434 prepares current on-vehicle unit history data, indicative of the calculated date and the on-vehicle unit detection frequency, which is registered in the specified data area of the distraction database 433. Thereafter, the operation is routed back to step S401.

The driving status detection device 4 repeatedly executes the on-vehicle unit history registering operation for a given period of time (of one month) and subsequently executes the on-vehicle unit history collating operation.

[On-Vehicle Unit History Collating Operation]

The distraction judgment section 434 recognizes the on-vehicle unit, which is an object to be operated by the driver, based on the on-vehicle unit detection signal delivered from the operation input discriminating section 436. Then, the distraction judgment section 434 specifies a data area, associated with the recognized on-vehicle unit, from the data areas of the distraction database 433. In addition, the distraction judgment section 434 discriminates whether on-vehicle unit history data is registered in the specified data area, that is, in other words, whether the recognized on-vehicle unit is registered in the distraction database 433.

As a result, if the recognized on-vehicle unit is registered in the distraction database 433, the distraction judgment section 434 detects the recognized on-vehicle unit to be a difficult on-vehicle unit which the driver feels difficult to operate. Then, the distraction judgment section 434 generates an operation-disabling signal S8 that is outputted to the interrupt message preparing section 435 and the operation input discriminating section 436.

In contrast, if no recognized on-vehicle unit is registered in the distraction database 433, the distraction judgment section 434 generates an operation permit signal S8′ that is outputted to the operation input discriminating section 436.

The interrupt message preparing section 435 generates an interrupt data signal, raising awareness to the driver to interrupt the operation of the on-vehicle unit, based on the operation-disabling signal delivered from the distraction calculating section 432, which in turn is outputted to the display device 44.

The operation input discriminating section 436 detects the operation, executed by the driver, and the on-vehicle unit, which forms an object to be operated by the driver, based on the operation signal delivered from the operation input device 41. Then, the operation input discriminating section 436 generates an on-vehicle unit detection signal, related to the on-vehicle unit and the operation thereof that are detected, which in turn is outputted to the distraction calculating section 432 and the distraction judgment section 434. As a result, if the operation-disabling signal is delivered from the distraction judgment section 434, the operation input discriminating section 436 clears out the operation signal. In contrast, if the operation permit signal is delivered from the distraction judgment section 434, the operation input discriminating section 436 outputs the operation signal to the display-menu preparing section 135 and the relevant on-vehicle unit associated with the operation signal.

Consequently, if the on-vehicle unit, detected by the operation input discriminating section 436, is registered in the distraction database 433, in other words, if the on-vehicle unit, detected by the operation input discriminating section 436, is detected as the difficult on-vehicle unit by the distraction judgment section 434, the operation to be executed on the on-vehicle unit, detected by the operation input discriminating section 436, is inhibited. On the contrary, if the on-vehicle unit, detected by the operation input discriminating section 436, is not registered in the distraction database 433, the driving status detection device 4 permits the operation of the relevant on-vehicle unit.

Therefore, with the operation of the relevant on-vehicle unit permitted, the driver is enabled to operate the relevant on-vehicle unit through the execution of the operation input device 41.

The display-menu preparing section 437 retrieves the display menu data, depending on the content of the operation signal delivered from the operation input discriminating section 436, from the menu structure storage section 438 for display over the display device 44. The menu structure storage section 438 stores a variety of display menu data.

The display device 44 provides a display of content, of the interrupt data signal delivered from the interrupt message preparing section 435, and content of the display menu data delivered from the display menu generating section 437 over the screen.

Next, the on-vehicle unit history collating operation is described more in detail in time series with reference to FIG. 10.

As shown in FIG. 10, if in step S408, a driver operates the operation input device 41; the operation input device 41 generates an operation signal depending on such operation. Then, the operation input device 41 outputs the resulting operation signal to the on-vehicle computer 43.

In next step S409, the operation input discriminating section 436 generates an on-vehicle unit detection signal, based on the operation signal delivered from the operation input device 41, which in turn is outputted to the distraction judgment section 434.

In succeeding step S410, the distraction judgment section 434 recognizes the relevant on-vehicle unit, which is an object to be operated by the driver, based on the on-vehicle unit detection signal delivered from the operation input discriminating section 436.

In subsequent step S411, the distraction judgment section 434 specifies a data area, associated with the recognized relevant on-vehicle unit, from the data areas of the distraction database 433. Then, the distraction judgment section 434 discriminates whether on-vehicle unit history data is registered in the specified data area, in other words, whether the recognized relevant on-vehicle unit is registered in the distraction database 433.

As a result, if the recognized relevant on-vehicle unit is registered in the distraction database 433, the operation proceeds to step S414 and, if not (with NO in step S411), the operation proceeds to step S412.

With the operation routed to step S412, the distraction judgment section 434 generates an operation permit signal that is outputted to the operation input discriminating section 436. Then, the operation input discriminating section 436 outputs the operation signal, delivered from the operation input discriminating section 436, to the display-menu preparing section 437 and the relevant on-vehicle unit with which the operation signal is associated. Next, the relevant on-vehicle unit executes the operation depending on the content of the operation signal delivered from the operation input discriminating section 436. This enables the driver to operate the relevant on-vehicle unit through the use of the operation input device 41.

Further, the display-menu preparing section 437 retrieves the display menu data signal, associated with the operation signal delivered from the operation input discriminating section 436, from the menu structure storage section 438 for display over the display device 44.

In succeeding step S413, the display device 44 provides a display of the content of the display menu data signal, delivered from the display menu generating section 436, over the screen. This allows the driver to continuously operate the relevant on-vehicle unit depending on the display menu displayed over the display device 44. Thereafter, the operation is routed back to step S408.

On the contrary, with the operation routed to step S414, the distraction judgment section 434 detects the relevant on-vehicle unit, recognized in step S410, as a difficult on-vehicle unit. Consecutively, the distraction judgment section 434 generates an operation-disabling signal, which in turn is outputted to the interrupt message preparing section 435 and the operation input discriminating section 436.

Then, the operation input discriminating section 436 clears out the operation signal delivered from the operation input device 41. This disables the operation of the on-vehicle unit, thereby disabling the operation of the on-vehicle unit.

Additionally, the interrupt message preparing section 435 generates an interrupt data signal, raising awareness to the driver to interrupt the operation of the on-vehicle unit, based on the operation-disabling signal delivered from the distraction calculating section 432, which in turn is outputted to the display device 44.

In succeeding step S415, the display device 44 provides a display of the interrupt data signal delivered from the interrupt message preparing section 435. Thereafter, the driving status detection device 4 allows the operation to be routed back to step S408.

With the presently filed embodiment, as set forth above, the driving status detection device 4 is enabled to detect the difficult on-vehicle unit which the driver feels difficult to operate. Also, the driving status detection device 4 is operative to inhibit the operation of only the difficult on-vehicle unit among the on-vehicle units installed on the vehicle. Moreover, the driving status detection device 4 is operative to inhibit the operation of only the difficult on-vehicle unit without a need for calculating a jerk square-sum after the on-vehicle unit has been registered in the distraction database 433 once, thereby enabling simplification of the operation to interrupt the operation of the difficult on-vehicle unit.

Incidentally, while, with the presently filed embodiment, the driving status detection device 4 has been described with reference to an exemplary case where the on-vehicle unit, registered in the distraction database 433, is detected as a difficult on-vehicle unit to disable the operation of the difficult on-vehicle unit, an on-vehicle unit, registered in the distraction database 433 a given number of times, may be detected as a difficult on-vehicle unit to allow only the operation of the detected difficult on-vehicle unit to be inhibited. Moreover, the driving status detection device 4 may permit the operation of the on-vehicle unit, which has been registered in the distraction database 433 once during the on-vehicle unit history registering operation but not subsequently and consecutively registered therein for a fixed period of time (of two weeks), in a subsequent on-vehicle unit history collating operation.

With the presence of such an availability of these operations, the driving status detection device 4 is able to inhibit the operation of the on-vehicle unit in a more appropriate manner.

### Fifth Embodiment

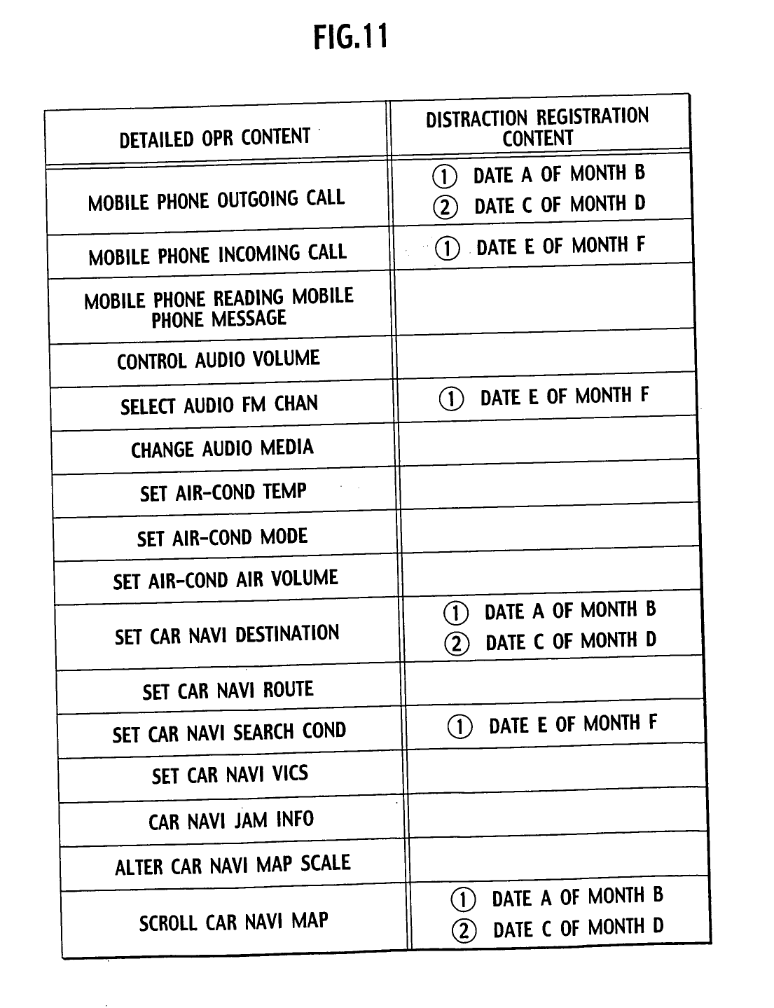

Next, a driving status detection device and its related method of a fifth embodiment according to the present invention are described in detail with reference to FIGS. 11 to 13.

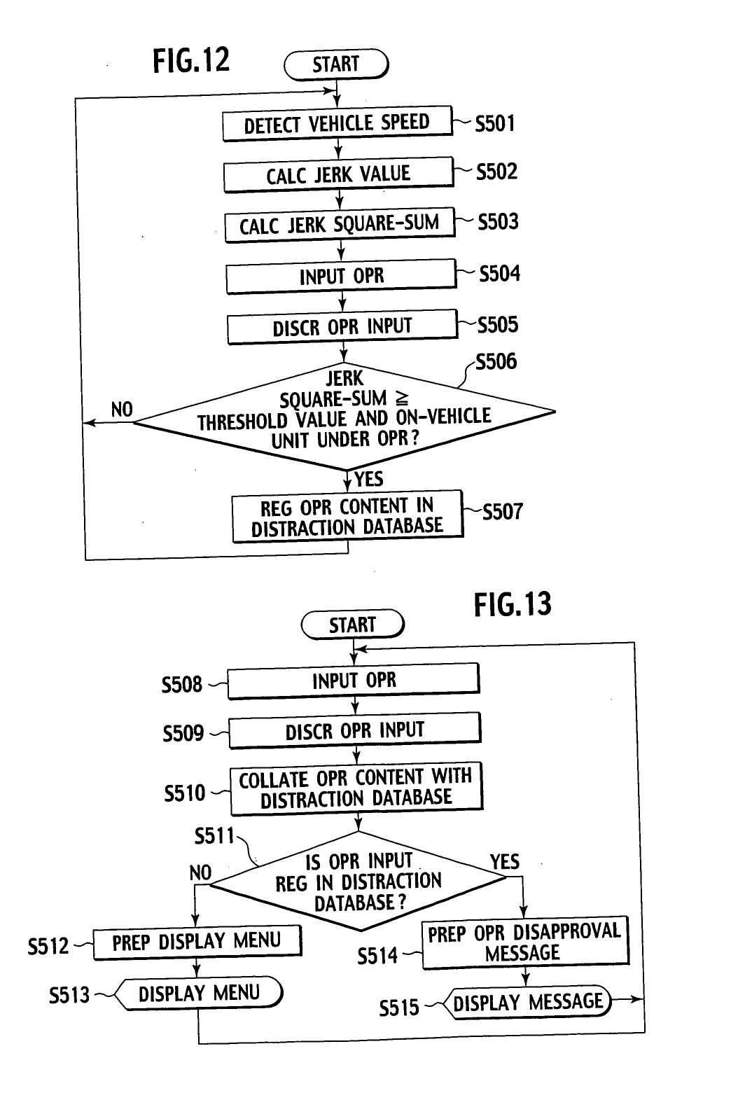

FIG. 11 is a view illustrating one example of a distraction database for the driving status detection device of the presently filed embodiment; FIG. 12 is a flowchart illustrating a basic sequence of operations of the driving status detection device of the presently filed embodiment; and FIG. 13 is a flowchart illustrating a basic sequence of operations to be executed by the driving status detection device of the presently filed embodiment.

Although the driving status detection device 5 of the presently filed embodiment is described with reference to FIGS. 7 and 11 for the sake of convenience, the driving status detection device 5 of the presently filed embodiment mainly differs from that of the fourth embodiment in respect of a difference in a structure of the distraction database 443 and a content in operation of a distraction discriminating section 444. Hereunder, with attention focused on such differences, the same component parts bear like reference numerals and description is suitably omitted or description is made in a simplified form.

A distraction database 443 of the driving status detection device 5, shown in FIG. 7, includes a data area for each detailed operation content for each on-vehicle unit, such as a data area for each of incoming and outgoing calls of a mobile phone, as shown in FIG. 11 in more in detail, and each data area is registered with operation history data, as a distraction-registered content, which is generated by the distraction discriminating section 444. Detailed content of operation history data will be described later.

The distraction discriminating section 444 includes a timer, which is not shown, and executes operation history registering operation and operation history collating operation that will be described below.

[Operation History Registering Operation]

Upon receipt of both signals applied from both the distraction calculating section 432 and the operation input discriminating section 436, the distraction discriminating section 444 recognizes the presence of operation executed by a driver based on an on-vehicle unit detection signal delivered from the operation input discriminating section 436.

Then, the distraction discriminating section 444 calculates the current date using the timer. Also, the distraction discriminating section 444 specifies a data area, associated with the recognized operation, from the data areas of the distraction database 443 and retrieves the newest operation history data based on the specified data area.

Subsequently, the distraction discriminating section 444 increments a frequency, in which the operations are detected, indicative of the acquired newest operation history data, by one to calculate the current operation detection frequency.

Additionally, the distraction discriminating section 444 generates the current operation history data, representing the calculated current date and the operation detection frequency and registers these content in the specified data area of the distraction database 443.

In the meanwhile, upon receipt of a signal from only one of the distraction calculating section 432 and the operation input calculating section 436, the distraction discriminating section 444 clears out this applied signal.

Accordingly, the date registered in each data area designates the date and month on which the driver distraction and the operation, associated with each data area, are detected by both the distraction calculating section 432 and the operation input calculating section 436. Also, the operation detection frequency, registered in each data area, indicates the number of times both the driver distraction and the operation, associated with each data area, are detected by the distraction calculating section 432 and the operation input calculating section 436, respectively, during a period between the start of commencing the operation history registering operation and the date and month corresponding to the date associated with the operation detection frequency. The date, designated by the newest operation history data corresponding to an item “OUTGOING CALL FROM MOBILE PHONE”, is “DATE C OF MONTH D” and the operation detection frequency is “2”.

Accordingly, the operation, whose operation history data is registered in the data area, can be said to be difficult on-vehicle unit which the driver feels difficult to operate. Also, it can be said that the greater the registration frequency of operation history data, the more difficult will be the operation to be executed by the driver.

Now, the operation history registering operation is described more in detail in time series with reference to FIG. 12.

In step S501 shown in FIG. 12, the vehicle speed detector 42 detects a speed of a vehicle and generates a speed signal related to the detected vehicle speed. Consecutively, the vehicle speed detector 42 outputs the resulting speed signal to the on-vehicle computer 43.

Next, in step S502, the preprocessing section 431 calculates a jerk value of the vehicle based on the speed signal delivered from the vehicle speed detector 42.

In subsequently step S503, the preprocessing section 431 calculates a jerk square-sum based on the calculated jerk value. Then, the preprocessing section 431 generates a jerk square-sum signal, related to the calculated jerk square-sum, which in turn is outputted to the distraction calculating section 432.

In succeeding step S504, upon the operation of the operation input device 41 executed by the driver, the operation input device 41 generates an operation signal, related to the operation of the on-vehicle unit, depending on such operation. Subsequently, the operation input device 41 outputs the resulting operation signal to the on-vehicle computer 43. Thereafter, the driving status detection device 5 allows the operation to proceed to step S505. In contrast, if the driver does not operate the operation input device 41, the driving status detection device 5 allows the operation to proceed to step S505 without generating and outputting the operation signal.

Next, in step S505, when applied with the operation signal from the operation input device 41, the operation input discriminating section 436 generates an on-vehicle unit detection signal, based on such an operation signal, which in turn is outputted to the distraction calculating section 432 and the distraction discriminating section 444. Thereafter, the driving status detection device 5 allows the operation to proceed to step S506. On the contrary, if no operation signal is applied to the operation input discriminating section 436 from the operation input device 41, the driving status detection device 5 allows the operation to proceed to step S506 without generating and outputting the on-vehicle unit detection signal.

Consecutively, in step S506, when applied with the on-vehicle unit detection signal from the operation input discriminating section 436, the distraction calculating section 432 sets a reference value, which corresponds to the operation of the on-vehicle unit executed by the driver, based on the on-vehicle unit detection signal.

Additionally, the distraction calculating section 432 makes comparison between the jerk square-sum and the settled reference value based on the jerk square-sum signal delivered from the preprocessing section 431. As a result, if the jerk square-sum exceeds the reference value, the distraction calculating section 432 detects driver distraction. Consecutively, the distraction calculating section 432 generates a distraction detection signal, which in turn is outputted to the distraction judgment section 434. In contrast, if no on-vehicle unit detection signal is applied to the distraction calculating section 432 or if the jerk square-sum is less than the reference value, the distraction calculating section 432 generates no distraction detection signal.

Further, the distraction discriminating section 444 discriminates whether the signals are applied from both the distraction calculating section 432 and the operation input discriminating section 436. As a result, if both the signals are applied, the operation proceeds to step S507. On the contrary, with the signal applied from only one of the distraction calculating section 432 and the operation input discriminating section 436 (with NO in step S506), the distraction judgment section 434 clears out the applied signal. Thereafter, the operation is routed back to step S501.

With the operation routed to step S507, the distraction discriminating section 444 recognizes the on-vehicle unit, which the driver operates, based on the on-vehicle unit detection signal delivered from the operation input discriminating section 436.

The distraction discriminating section 444 calculates the current date using the timer. Also, the distraction discriminating section 444 specifies the data area, associated with the recognized operation, from the data areas of the distraction database 443 to allow the newest operation history data to be retrieved from the specified data area.

In addition, the distraction discriminating section 444 increments an operation detection frequency, indicated by the retrieved newest operation history data, by one, thereby calculating the current operation detection frequency.

Subsequently, the distraction discriminating section 444 prepares current operation history data indicative of the calculated date and the operation detection frequency and registers the same in the specified data area of the distraction database 443. Thereafter, the operation is routed back to step S501.

The driving status detection device 5 repeatedly executes the operation history registering operation for a given period of time (of one month) and subsequently executes the operation history collating operation.

[Operation History Collating Operation]

The distraction discriminating section 444 recognizes the presence of operation executed by the operator based on the operation detection signal delivered from the operation input discriminating section 436. Then, the distraction discriminating section 444 specifies a data area, associated with the recognized operation, from the data areas of the distraction database 443. In addition, the distraction discriminating section 444 discriminates whether operation history data is registered in the specified data area, that is, in other words, whether the recognized operation is registered in the distraction database 443.

As a result, if the recognized operation is registered in the distraction database 443, the distraction discriminating section 444 detects the recognized operation to be difficult operation for the driver. Then, the distraction discriminating section 444 generates an operation-disabling signal that is outputted to the interrupt message preparing section 435 and the operation input discriminating section 436.

In contrast, if no recognized operation is registered in the distraction database 443, the distraction discriminating section 444 generates an operation permit signal that is outputted to the operation input discriminating section 436.

Consequently, if the operation, detected by the operation input discriminating section 436, is registered in the distraction database 443, in other words, if the operation, detected by the operation input discriminating section 436, is detected as the difficult operation by the distraction discriminating section 444, the operation, detected by the operation input discriminating section 436, is inhibited. On the contrary, if the operation, detected by the operation input discriminating section 436, is not registered in the distraction database 443, the driving status detection device 5 permits the operation.

Therefore, with the operation permitted, the driver is enabled to operate the on-vehicle unit the operation input device 41.

Next, the on-vehicle unit history collating operation is described more in detail in time series with reference to FIG. 13.

In step S508 shown in FIG. 13, upon operation of the operation input device 41 executed by the driver, the operation input device 41 generates an operation signal associated with such operation. Then, the operation input device 41 outputs the generated operation signal to the on-vehicle computer 43.

In next step S509, the operation input discriminating section 436 generates an on-vehicle unit detection signal, based on the operation signal delivered from the operation input device 41, which in turn is outputted to the distraction discriminating section 444.

In consecutive step S510, the distraction discriminating section 444 recognizes the operation executed by the driver based on the on-vehicle detection signal delivered from the operation input discriminating section 436.

Further, the distraction discriminating section 444 specifies a data area, associated with the recognized operation, from the data areas of the distraction database 443. Then, the distraction discriminating section 444 discriminates whether operation history data is registered in the specified data area, in other words, whether the recognized operation is registered in the distraction database 443.

As a result, if the recognized operation is registered in the distraction database 443, the operation proceeds to step S514 and, if not (with NO in step S511), the operation proceeds to step S512.

With the operation routed to step S512, the distraction discriminating section 444 generates an operation permit signal, which in turn is outputted to the operation input discriminating section 436. Then, the operation input discriminating section 436 outputs the operation signal, delivered from the operation input discriminating section 436, to the display-menu preparing section 437 and the relevant on-vehicle unit associated with the operation signal. Next, the relevant on-vehicle unit executes the operation depending on the content of the operation signal delivered from the operation input discriminating section 436. This enables the driver to operate the relevant on-vehicle unit using the operation input device 41.

Further, the display-menu preparing section 437 retrieves the display menu data signal, associated with the operation signal delivered from the operation input discriminating section 436, from the menu structure storage section 438 for display over the display device 44.

In succeeding step S513, the display device 44 provides a display of the content of the display menu data signal, delivered from the display menu generating section 436, over the screen. This allows the driver to continuously operate the relevant on-vehicle unit depending on the display menu displayed over the display device 44. Thereafter, the operation is routed back to step S508.

On the contrary, with the operation routed to step S514, the distraction discriminating section 444 detects the relevant operation, recognized in step S510, as difficult operation for the driver. Consecutively, the distraction judgment section 434 generates an operation-disabling signal, which in turn is outputted to the interrupt message preparing section 435 and the operation input discriminating section 436.

Then, the operation input discriminating section 436 clears out the operation signal delivered from the operation input device 41. This disables the operation of the relevant on-vehicle unit, thereby disabling the operation of the on-vehicle unit.

Additionally, the interrupt message preparing section 435 generates an interrupt data signal, raising awareness to the driver to interrupt the operation of the on-vehicle unit, based on the operation-disabling signal delivered from the distraction calculating section 432, which in turn is outputted to the display device 44.

In succeeding step S515, the display device 44 provides a display of the content of the interrupt data signal, delivered from the interrupt message preparing section 435, over a screen. Thereafter, the operation is routed back to step S508.

With the presently filed embodiment, as set forth above, the driving status detection device 5 is enabled to detect the difficult operation for the driver. Also, the driving status detection device 5 is operative to inhibit only the difficult operation for the driver among the operations of the on-vehicle unit. Moreover, the driving status detection device 5 is operative to render the difficult operation to be an object to be disabled without a need for calculating a jerk square-sum after the relevant operation has been registered in the distraction database 443 once, thereby enabling simplification of the operation to interrupt the difficult operation.

Incidentally, while, with the presently filed embodiment, the driving status detection device 5 has been described with reference to an exemplary case where the operation, registered in the distraction database 443, is detected as the difficult operation whereby the difficult operation is disabled, one of various operations registered in the distraction database 443 a given number of times may be detected as difficult operation to allow only the detected operation to be disabled. Moreover, the driving status detection device 5 may be configured such that the operation, which has been registered in the distraction database 443 once during the preceding on-vehicle history registering operation but not consecutively registered in subsequent operations for a fixed period of time (of two weeks), is permitted in subsequent on-vehicle unit history collating operation.

With the presence of these operations, the driving status detection device 5 is able to render the on-vehicle unit inoperative to more appropriately inhibit the operation.

Incidentally, while the first to fifth embodiments, the jerk square-sum is calculated as the jerk conversion value, an alternative may allow an absolute value of the jerk value to be calculated. Even in such a case, it becomes possible to have the same advantageous effects as those described above.

Moreover, while in the first to fifth embodiments, the driving status detection devices 1 to 5 are arranged to calculate the jerk square-sum when the driver operates the operation input device 11, another alternative may be arranged such that the jerk square-sum is calculated before the driver operates the operation input device 11. In this case, such another alternative enables faster detection of the driver distraction.

### Sixth Embodiment

Now, a driving status detection device and its related method of a sixth embodiment according to the present invention are described in detail.

The presently filed embodiment has a structure in which, under circumstances where a jerk conversion value, resulting from a so-called jerk value related to a speed of a vehicle, exceeds a reference range, a driving status of the vehicle upon detection is detected as a difficult drive condition forming one of risk occurrence scenes for a driver, and such a structure differs from those of the embodiments 1 to 5. Hereunder, with an attention focused on such a difference, the same component parts bear like reference numerals and description is made in a suitably omitted or simplified form.

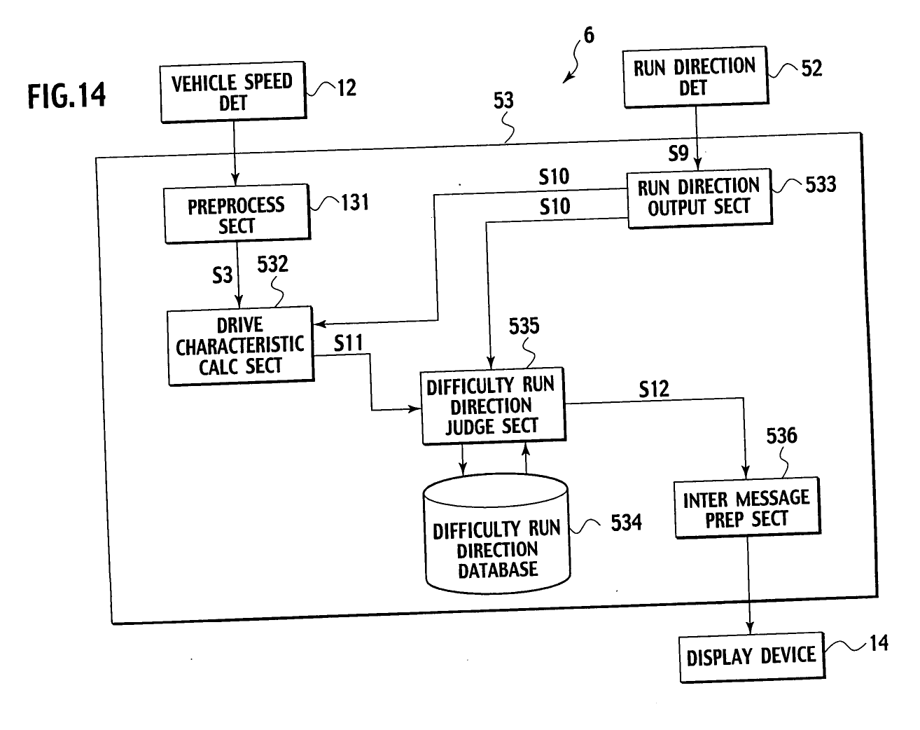

Referring to FIGS. 14 to 17, the driving status detection device and related method are described more in detail.

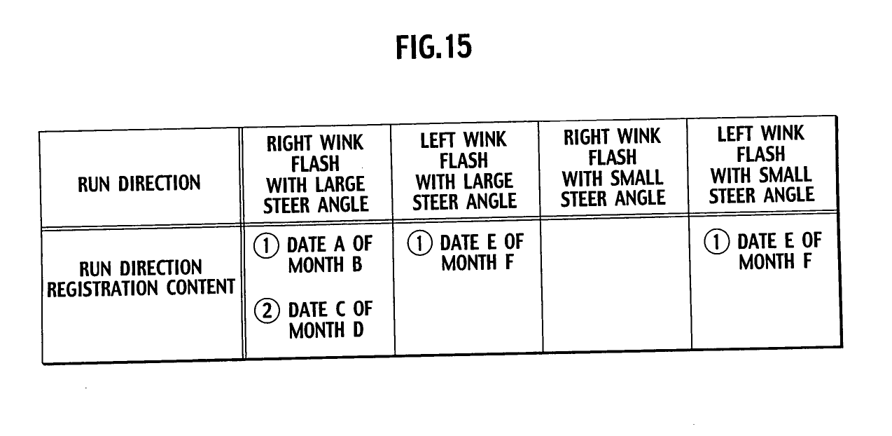

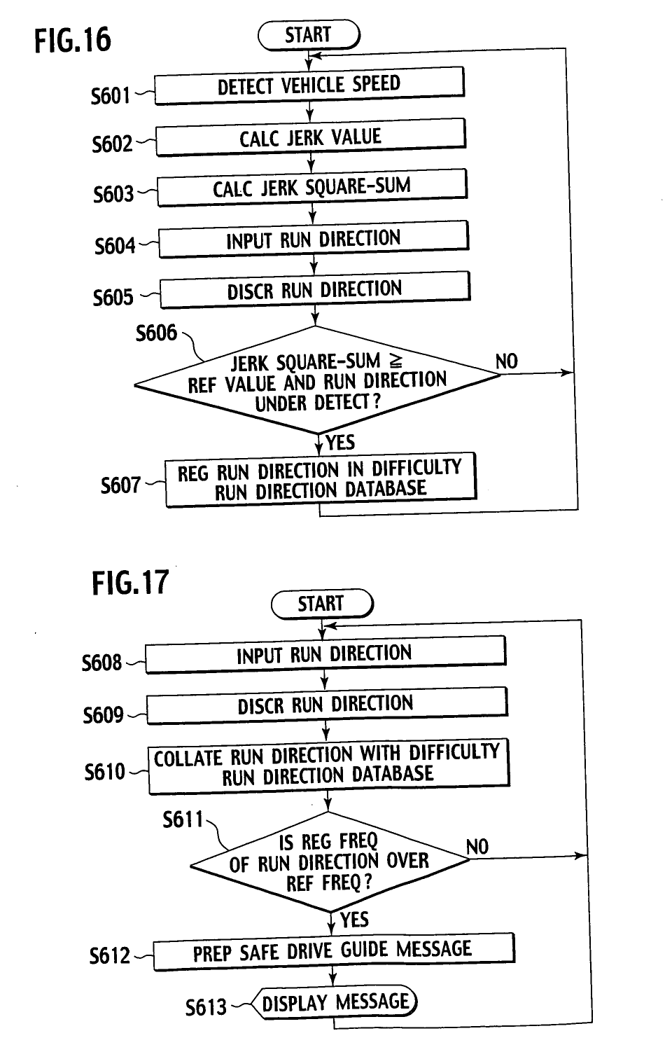

FIG. 14 is a block diagram showing a structure of the driving status detection device of the presently filed embodiment; FIG. 15 is a view illustrating one example of a difficult running direction database of the present invention; FIG. 16 is a flowchart illustrating a basic sequence of operations of the driving status detection device of the presently filed embodiment; and FIG. 17 is a flowchart illustrating another basic sequence of operations of the driving status detection device of the presently filed embodiment.

As shown in FIG. 14, the driving status detection device 6, which is installed on a vehicle, is comprised of a vehicle speed detector 12, a running direction detector 52, an on-vehicle computer 53 and a display device 14. The on-vehicle computer 53 includes a preprocessing section 131, a driving characteristic calculating section 532, a running direction output section 533 by which a driving status is detected, a difficult running direction database 534, a difficult running direction judgment section 535 by which a difficult status is detected, and an interrupt message preparing section 536.

The vehicle speed detector 12 detects a speed, in a running direction of a vehicle as behavior of the vehicle, that is, a vehicle speed, to generate a vehicle speed signal related to the detected vehicle speed. Then, the vehicle speed detector 12 outputs the generated vehicle speed signal to the preprocessing section 131. Also, the vehicle speed detector 12 may include a vehicle-wheel speed sensor and is similar to that of the first embodiment.

The running direction detector 52 is comprised of a steering angle sensor, by which a rotational angle (hereinafter referred to as a steering angle) of a steering wheel is detected, and a winker sensor by which flushing statuses of a winker is detected, with sensor signals S9, outputted from these sensors, being outputted to the difficult running direction judgment section 535.

The preprocessing section 131, which is similar to that of the first embodiment, calculates a plurality of jerk values, related to the vehicle speed, based on the vehicle speed signal delivered from the vehicle speed detector 12 and, depending on these calculated plural jerk values, further calculates an integrated value of squared jerk values, that is, jerk square-sums, as a jerk conversion value.

Then, the preprocessing section 131 generates a jerk square-sum signal S3, related to the calculated jerk square-sum, which in turn is outputted to the driving characteristic calculating section 532.

The driving characteristic calculating section 532 sets a reference value, depending on the running direction of the vehicle, based on the running direction detection signal S10 delivered from the running direction output section 533 that will be described later. Here, the reference value is set such that the reference value takes a minimal value under a situation where the running direction of the vehicle lies in a straight direction and increases with an increase in displacement of the running direction of the vehicle with respect to the straight direction. This is because the increase in displacement of the running direction of the vehicle with respect to the straight direction increases a probability for a driver to encounter a feeling of difficult operation in such a deviated running direction. Also, a range less than the reference value forms a reference range.

The driving characteristic calculating section 532 discriminates whether the jerk square-sum exceeds the reference value depending on the jerk square-sum signal delivered from the preprocessing section 131.

As a result, only in an event that the jerk square-sum exceeds the reference value, the driving characteristic calculating section 532 generates a difficult judgment permit signal S11, which in turn is outputted to the difficult running direction judgment section 535.

The running direction output section 533 detects the running direction of the vehicle, as a driving status of the vehicle, based on the sensor signal delivered from the running direction detector 52. Also, with the presently filed embodiment, the running direction is designated in terms of the flushing condition of the winker and the degree of the steering angle (in a way as to whether the steering angle is greater than or less than a given steering angle, that is, whether the degree of the steering angle is large or small). Then, the running direction detector 52 generates the running direction detection signal S10, related to the detected running direction of the vehicle, which in turn is outputted to the driving characteristic calculating section 532 and the difficult running direction judgment section 535.

The difficult running direction database 534 has a data area for each running direction, such as one in which the winker is flushing on right side and the steering angle is large, as shown in FIG. 15. Registered in each data area to indicate running direction registration content is running direction history data that is generated by the difficult running direction judgment section 535. A detailed content of running direction history data will be described below.

The difficult running direction judgment section 535 includes a timer, which is not shown, and executes running direction history registering operation and running direction history collating operation.

[Running Direction History Registering Operation]

The difficult running direction judgment section 535 recognizes the running direction of the vehicle based on the running direction detection signal delivered from the running direction detector 533 when applied with signals from both the running direction output section 533 and the driving characteristic calculating section 532.

Then, the difficult running direction judgment section 535 calculates the current date using the timer. Also, the difficult running direction judgment section 535 specifies a data area, associated with the recognized running direction, in the data areas of the difficult running direction database 534 and discriminates whether running direction history data is registered in the specified data area.

As a result, if running direction history data is registered in the specified data area, the difficult running direction judgment section 535 retrieves the newest running direction history data from the specified data area. Then, the difficult running direction judgment section 535 increments a running direction detection frequency, represented by the newest running direction history data, by one to calculate the current running direction detection frequency.

If no running direction history data is registered in the specified data area, the difficult running direction judgment section 535 calculates the current running direction detection frequency as “1”.

Additionally, the difficult running direction judgment section 535 generates the current running direction history data, indicative of the calculated current date and running direction detection frequency, and registers these content in the specified data area among the data areas of the difficult running direction database 534. That is, the running direction is registered. The date, represented by the newest running direction history data corresponding to the content of “RIGHT WINKER FLUSHING WITH LARGE STEERING ANGLE”, lies on DATE A of MONTH B and the running direction detection frequency is “2”.

Accordingly, the date, which is registered in each data area, indicates a date on which the jerk square-sum exceeds the reference value when the running direction detector 52 detects the running direction of the vehicle. Also, the running direction detection frequency registered in each running direction, that is, the registered frequency of the running direction, indicates the number of times in that the jerk square-sum exceeds the reference value when the running direction detector 52 detects the running direction of the vehicle during a time period from a time in which the running direction history registering operation is commenced to a day designated by the date corresponding to the running direction detection frequency.

Accordingly, it can be said that the running direction, registered in the difficult running direction database 534, is a running direction difficult for the driver to drive. Also, it can be said that the greater the frequency in which the running direction is registered, the more difficult will be the running direction for the driver.

Now, the running direction history registering operation is described in time series with reference to FIG. 16.

In step S601 as shown in FIG. 16, the vehicle speed detector 12 detects a speed of a vehicle and generates a speed signal related to the detected vehicle speed. Then, the vehicle speed detector 12 outputs the resulting vehicle speed signal to the preprocessing section 131.

Next, in step S602, the preprocessing section 131 calculates a jerk value of the vehicle based on the speed signal delivered from the vehicle speed detector 12.

In succeeding step S603, the preprocessing section 131 calculates a plurality of jerk values based on the vehicle speed applied from the vehicle speed detector 12 for a certain time interval and calculates a jerk square-sum based on the calculated plural jerk values. Then, the preprocessing section 131 generates a jerk square-sum signal, related to the calculated jerk square-sum, which in turn is outputted to the driving characteristic calculating section 532.

In consecutive step S604, the running direction detector 52 outputs the sensor signals, delivered from the steering sensor and the winker sensor, to the running direction output section 533.

Next, in step S605, the running direction output section 533 detects a running direction of the vehicle based on the sensor signals delivered from the running direction detector 52. Then, the running direction detector 52 generates a running direction detection signal, related to the detected running direction of the vehicle, which in turn is outputted to the driving characteristic calculating section 532 and the difficult running direction judgment section 535.

In succeeding step S606, the driving characteristic calculating section 532 sets a reference value, depending on the running direction of the vehicle, based on the running direction detection signal delivered from the running direction output section 533. Subsequently, the driving characteristic calculating section 532 discriminates whether the jerk square-sum exceeds the reference value based on the jerk square-sum signal delivered from the preprocessing section 131.

As a result, if the jerk square-sum exceeds the reference value, the operation proceeds to step S607 and, if the jerk square-sum is less than the reference value, the operation is routed back to step S601.

With the operation routed to step S607, the driving characteristic calculating section 532 generates a difficult judgment permit signal, which in turn is outputted to the difficult running direction judgment section 535. Then, the difficult running direction judgment section 535 recognizes the running direction of the vehicle based on the running direction detection signal delivered from the running direction output section 533.

The difficult running direction judgment section 535 calculates the current date using the timer. Also, the difficult running direction judgment section 535 specifies a data area, associated with the recognized running direction, from the data areas of the difficult running direction database 534 to discriminate whether running direction history data is registered in the specified data area.

As a result, if running direction history data is registered in the specified data area, the difficult running direction judgment section 535 retrieves the newest running direction history data from the specified data area. Then, the difficult running direction judgment section 535 increments the running direction detection frequency, represented by the retrieved newest running direction history data, by one to calculate the current running direction detection frequency.

On the contrary, if no running direction history data is registered in the specified data area, the difficult running direction judgment section 535 calculates the current running direction detection frequency as “1”.

The difficult running direction judgment section 535 generates the current running direction history data, indicative of the calculated current date and running direction detection frequency, and registers these contents in the specified data area of the difficult running direction database 534. Thereafter, the operation is routed back to step S601.

The driving status detection device 6 repeatedly executes the running direction history registering operations for a given time period (of one month) and, thereafter, executes the running direction history collating operation in a manner indicated below.

[Running Direction History Collating Operation]

The difficult running direction judgment section 535 recognizes the running direction of the vehicle based on the running direction detection signal delivered from the running direction output section 533. Then, the difficult running direction judgment section 535 specifies a data area, associated with the recognized running direction, from the data areas of the difficult running direction database 534. In addition, the difficult running direction judgment section 535 discriminates whether the number of times in which running direction history data is registered in the specified data area, that is, in other words, whether the number of times in which the registration is made in the difficult running direction database 534, exceeds a given reference number of times.

As a result, only in an event that the number of times, in which the registration is made in the difficult running direction database 534, exceeds the given reference number of times, the difficult running direction judgment section 535 detects the recognized running direction as the difficult running direction for the driver. Then, the difficult running direction judgment section 535 generates an interrupt message display signal that is outputted to the interrupt message preparing section 536.

The interrupt message preparing section 536 generates a safety drive data, raising awareness to the driver to perform safety drive, when applied with the interrupt message display signal from the difficult running direction judgment section 535, with the safety drive data being outputted to the display device 14. The display device 14 provides a display of a content of the safety drive data, delivered from the interrupt message preparing section 536, over a screen.

Next, the running direction history collating operation is described in time series with reference to FIG. 17.

In step S608 shown in FIG. 17, the running direction detector 52 outputs the sensor signals, outputted from the steering angle sensor and the winker sensor, to the running direction output section 533.

In next step S609, the running direction output section 533 detects a running direction of the vehicle, based on the sensor signals delivered from the running direction detector 52. Consecutively, the running direction detector 52 generates a running direction detection signal, related to the detected running direction of the vehicle, which in turn is outputted to the difficult running direction judgment section 535.

In succeeding step S610, the difficult running direction judgment section 535 recognizes the running direction detection signal delivered from the running direction output section 533. Subsequently, the difficult running direction judgment section 535 specifies a data area, associated with the recognized running direction, from the data areas of the difficult running direction database 534.

Then, in step S611, the difficult running direction judgment section 535 discriminates whether the number of times in which running direction history data is registered in the specified data area, that is, in other words, whether the number of times in which the registration is made in the difficult running direction database 534, exceeds a given reference number of times.

As a result, if the newest running direction detection frequency exceeds the given reference frequency, the operation proceeds to step S612 and, if the newest running direction detection frequency is less than the given reference frequency, the operation is routed back to step S608.

With the operation routed to step S612, the difficult running direction judgment section 535 detects the running direction, recognized in step S610, as the difficult running direction for the driver. Then, the difficult running direction judgment section 535 generates an interrupt message display signal that is outputted to the interrupt message preparing section 536. Upon receipt of the interrupt message display signal delivered from the difficult running direction judgment section 535, the interrupt message preparing section 536 generates safety drive data, raising awareness to the driver to perform safety drive, which in turn is outputted to the display device 14.

In succeeding step S613, the display device 14 provides a display of a content of safety drive data delivered from the interrupt message preparing section 536.

With the presently filed embodiment, as set forth above, the driving status detection device 6 detects a driving status of a vehicle detected by the running direction output section 533 as a difficult driving status for the driver in an event that the jerk conversion value exceeds the given reference range. Here, the reason why such an operation is possibly made is described below.

That is, the jerk value is a differentiated value of first order of the vehicle speed, in other words, a rate of change of acceleration per unit time. Also, as the accelerator pedal moves, the acceleration varies. Consequently, the greater the frequency of movement of the accelerator pedal and the higher the moving speed of the accelerator pedal, the greater will be the jerk square-sum.

In the meanwhile, if the driver wavers in the driving operation, the variation in the operation of the accelerator pedal increases. In particular, the larger the wavering with respect to the driving operation, the greater will be the frequency of movement in the accelerator pedal and the moving speed of the accelerator pedal.

Accordingly, the jerk conversion value in the presence of the wavering with respect to the driving operation differs from the jerk conversion value in the absence of the wavering. Therefore, the driving status detection device 6 can be arranged to operate the above-described processing, that is, the reference range is settled for the jerk conversion value whereby, when the jerk conversion value exceeds the reference value, the operation is executed to detect the wavering in the driver with respect to the driving operation. That is, the driving status difficult for the driver can be detected.

Here, even during normal driving operations, there is a characteristic in that the jerk conversion value exceeds the given reference range.

Further, under circumstances where the driving status difficult for the driver is detected, since the driving status detection device 6 provides an occupant of a vehicle with a display, over a screen, of safety drive data raising awareness to the driver to perform safety drive, it becomes possible to alert the driver in cases where the driver wavers in the driving operation.

Furthermore, since the driving status detection device 6 detects a driving status, in which the number of times, registered in the difficult running direction database 534, exceeds the reference number of times, as a driving status difficult for the driver, the driving status, difficult for the driver, can be reliably detected. Also, the driving status detection device 6 detects the driving status difficult for the driver without making comparison between the jerk conversion value and the reference value after the running direction history registering operation has been executed once, making it possible to simplify the operations to detect the driving status difficult for the driver.

Moreover, the driving status detection device 6 detects the running direction of the vehicle as the driving status difficult for the driver, enabling the detection of the running direction difficult or the driver.

Additionally, the driving status detection device 6 calculates the jerk square-sum as the jerk conversion value and, hence, it becomes possible to reliably detect the wavering of the driver with respect to the driving operation. Even when less variation occurs in the operation of the accelerator pedal at each point in time, the presence of variation in a continued manner increases the jerk square-sum and, so, the driving status detection device 6 has a capability of reliably detecting the wavering of the driver with respect to the driving operation.

Incidentally, while, with the presently filed embodiment, the driving status detection device 6 has been described in conjunction with an aspect wherein the jerk square sum is calculated as the jerk conversion value, an absolute value of the jerk value may be calculated as the jerk conversion value. In such case, the driving status detection device 6 has the same advantageous effects as those discussed above.

### Seventh Embodiment

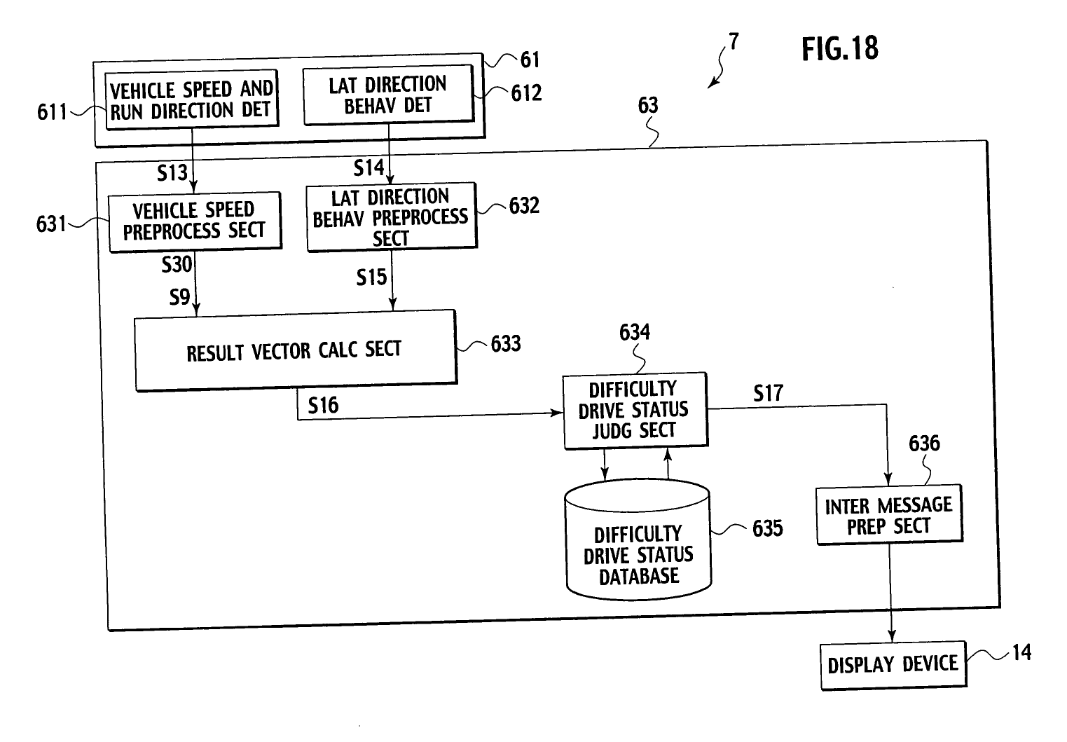

Now, a driving status detection device and its related method of a seventh embodiment according to the present invention are described in detail with reference to FIGS. 18 to 22.

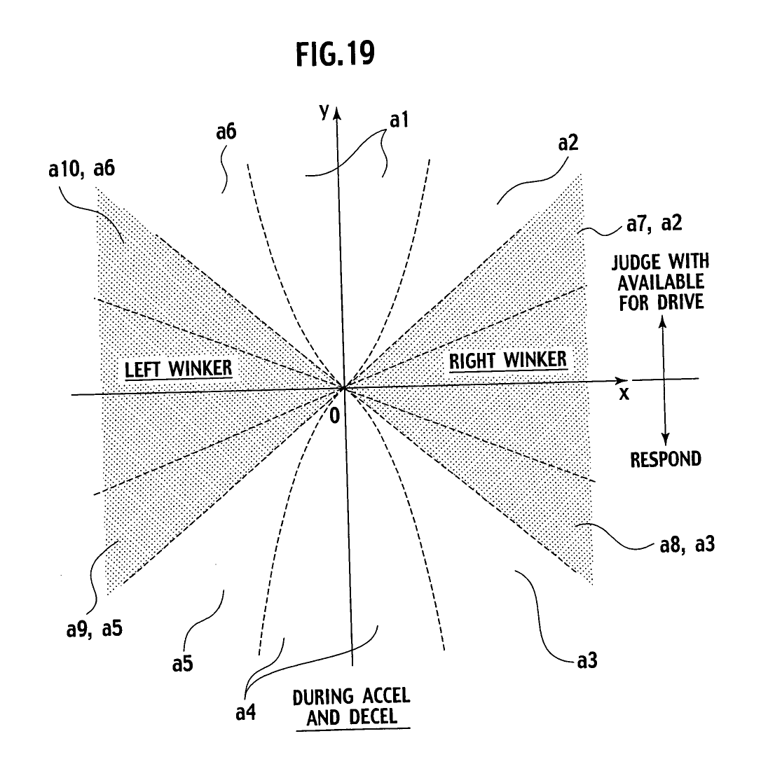

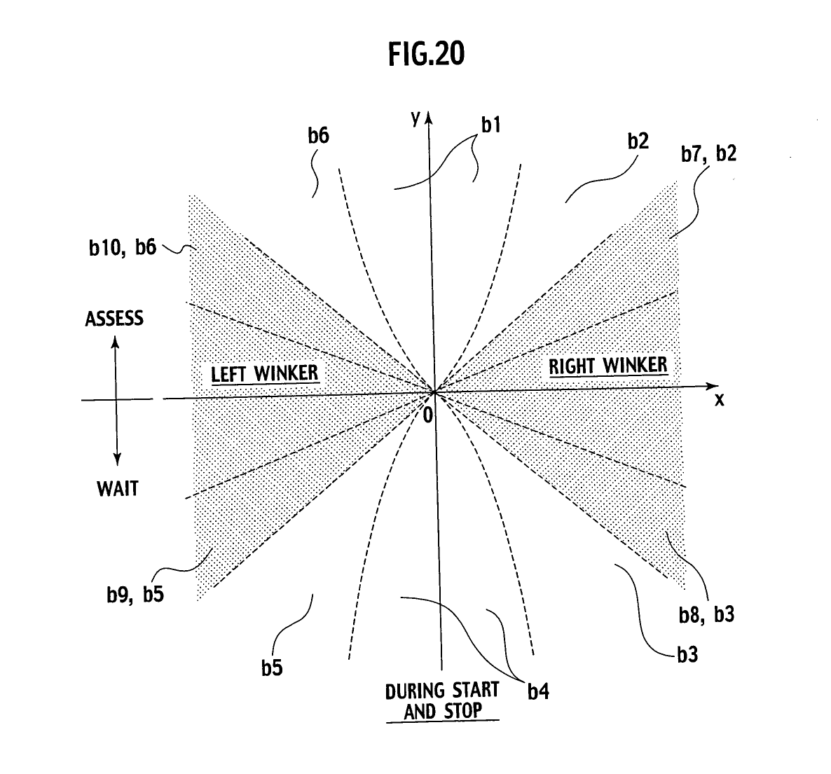

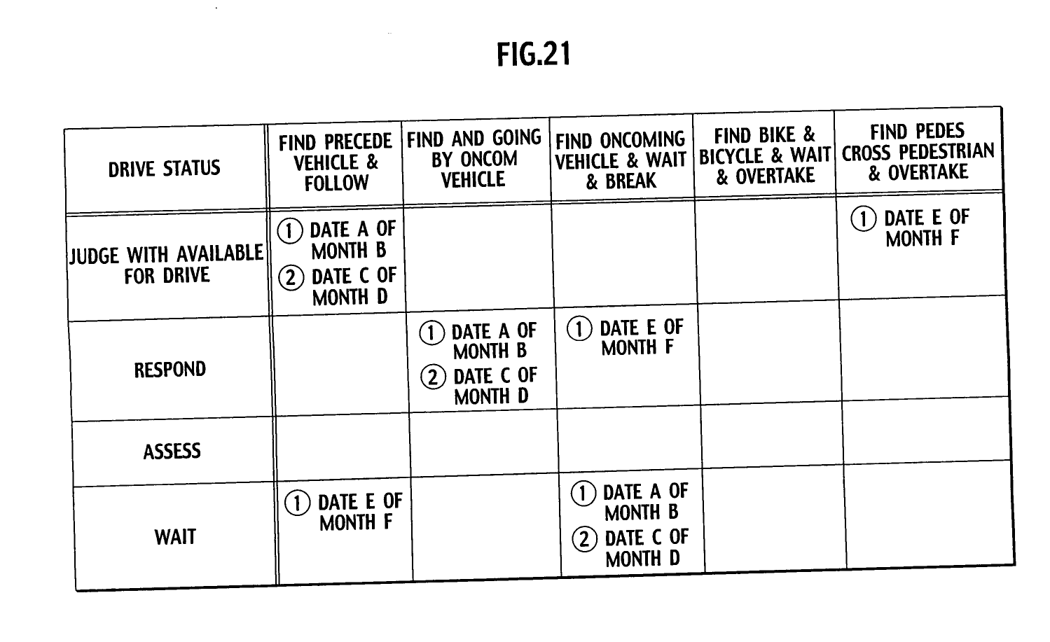

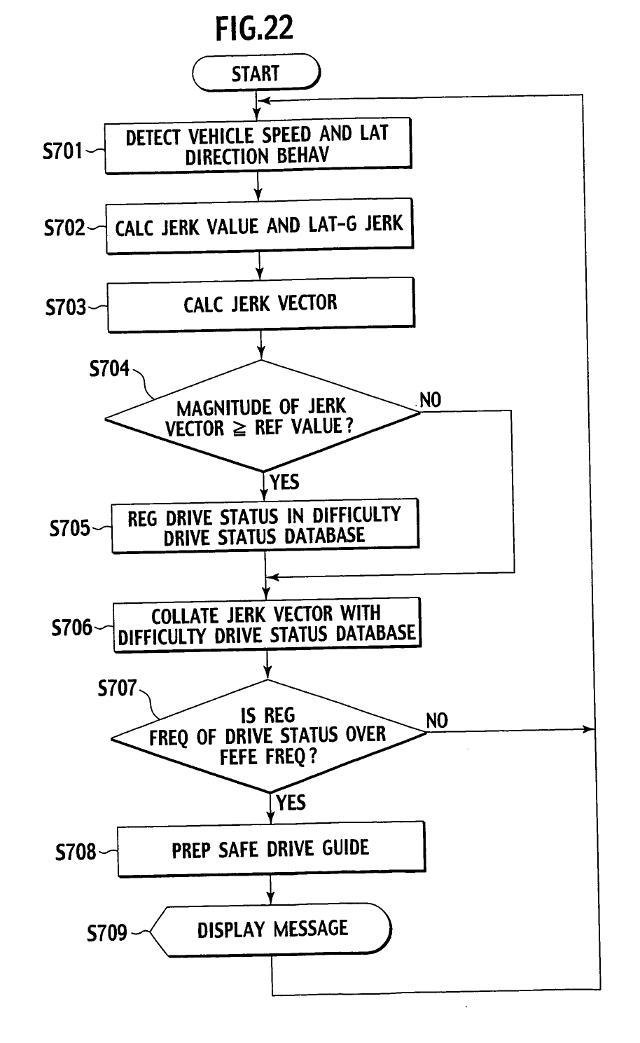

FIG. 18 is a block diagram showing a structure of the driving status detection device of the presently filed embodiment; FIG. 19 is a view illustrating a classification of a driving status of the presently filed embodiment; FIG. 20 is a view illustrating the classification of the driving status of the presently filed embodiment; FIG. 21 is a view illustrating one example of a difficult driving status database of the presently filed embodiment; and FIG. 22 is a flowchart illustrating a basic sequence of operations of the driving status detection device of the presently filed embodiment.

The driving status detection device 7 of the presently filed embodiment mainly differs from that of the sixth embodiment in respect of a vehicle behavior detection device 61 being used. Hereunder, with an attention focused on such a difference, the same component parts bear like component parts and description is suitably omitted or simplified.

As shown in FIG. 18, the driving status detection device 7 is comprised of a vehicle behavior detection device 61, an on-vehicle computer 63 and a display device 14. The vehicle behavior detection device 61 includes a vehicle speed and running direction detector 611 and a lateral-direction behavior detector 612. The on-vehicle computer 63 is comprised of a vehicle speed preprocessing section 631, a lateral-direction-behavior preprocessing section 632, a resultant vector calculating section 633, a difficult driving status judgment section 634, a difficult driving status database 635 and an interrupt message preparing section 636.

The vehicle speed and running direction detector 611 detects the running of a vehicle and a flashing condition of a winker as well as a vehicle speed. Then, the vehicle speed and running direction detector 611 generates sensor signals S9, related to the detected running of the vehicle and flashing condition of the winker, as well as a running direction behavior signal S13 involving a vehicle speed signal S2. The vehicle speed and running direction detector 611 outputs the generated running direction behavior signal S13 to the vehicle speed preprocessing section 631.

The lateral-direction behavior detector 612 detects acceleration (in particular, acceleration, acting on a vehicle in a direction perpendicular to a running direction of the vehicle, which will be hereinafter merely referred to as “lateral-G”). Then, the lateral-direction behavior detector 612 generates a lateral-G signal S14, related to the detected lateral-G, which in turn is outputted to the lateral-direction-behavior preprocessing section 632.

The vehicle speed preprocessing section 631 calculates a jerk value, related to the vehicle speed, based on the vehicle speed involved in the running direction behavior signal S13 delivered from the vehicle speed and running direction detector 611. Then, the vehicle speed preprocessing section 631 generates a jerk signal S3, related to the calculated jerk value, which in turn is outputted to resultant vector calculating section 633.

The lateral-direction-behavior preprocessing section 632 generates a lateral-G jerk value, related to the lateral-G, based on the lateral-G signal delivered from the lateral-direction behavior detector 612. As used herein, the term “lateral-G jerk value” refers to a value obtained by differentiating the lateral-G in first order. Then, a lateral-G jerk signal S15, related to the calculated lateral-G jerk value, is generated and outputted to the resultant vector calculating section 633.

The resultant vector calculating section 633 calculates a jerk vector, as a jerk conversion value, based on the jerk signal and the lateral-G jerk signal applied from the vehicle speed preprocessing section 631 and the lateral-direction-behavior preprocessing section 632, respectively, for a given time interval.

Here, the magnitude SJJG (tn) of the jerk vector at a certain time tn is a sum, which is obtained by adding the results of a square J2 of the jerk value and a square JG2 of the lateral-G jerk value that are counted from time t (n−m) to time (n+m), respectively, and expressed in a formula described below wherein n and m represent positive integers.

$$\begin{matrix}SJJG ( tn ) = {J}^{2} ( t ( n - m ) ) + {JG}^{2} ( t ( n - m ) ) + {J}^{2} ( t ( n - m + 1 ) ) + \\ {JG}^{2} ( t ( n - m + 1 ) ) + … + {J}^{2} ( t ( n + m ) ) + {JG}^{2} ( t ( n + m ) ) \\ = Σ ( {J}^{2} ( t = t ( n - m ) … t ( n + m ) ) + \\ {JG}^{2} ( t = t ( n - m ) … t ( n + m ) )\end{matrix}$$

In this connection, a directionθG of the jerk vector at a certain time tn is expressed by a formula (1), as described below, in cases where the vehicle speed is increasing (that is, during acceleration) and a direction of the lateral-G is oriented rightward, and expressed by a formula (2), as described below, in cases where the vehicle speed is accelerating and the direction of the lateral-G oriented leftward. Also, the directionθG of the jerk vector at certain time tn is expressed by a formula (3), as described below, in cases where the vehicle speed is decreasing (that is, during deceleration) and the direction of the lateral-G is oriented rightward, and expressed by a formula (4), as described below, in cases where the vehicle speed is decelerating and the direction of the lateral-G oriented leftward. Incidentally, “arctan” in each formula represents an inverse function of “tan”.
θG=arctan(ΣJ²/ΣJG²) (1)
θG=arctan(−ΣJ²/ΣJG²) (2)
θG=−arctan(ΣJ²/ΣJG²) (3)
θG=−arctan(−ΣJ²/ΣJG²) (4)

Then, the resultant vector calculating section 633 generates a jerk vector signal S16, related to the calculated jerk vector, the vehicle speed and the flashing condition of the winker, which in turn is outputted to the difficult driving status judgment section 634.

The difficult driving status judgment section 634 includes a timer, which is not shown, and discriminates whether the vehicle is running and whether the winker is flashing based on the jerk vector signal delivered from the resultant vector calculating section 633. As a result, during a period in which the vehicle is running, the difficult driving status judgment section 634 detects a driving status of the vehicle in accordance with the classification of the driving status shown in FIG. 19.

More particularly, the classification shown in FIG. 19 is defined on an x-y plane and jerk vectors extending from an origin “O” on the x-y plane. Here, a positive direction on the x-axis (rightward) corresponds to a right direction with respect to a running direction of a vehicle and a positive direction on the y-axis (frontward) is aligned with the running direction of the vehicle.

As a result, the difficult driving status judgment section 634 detects respective driving statuses of the vehicle, depending on a vector area on the x-y plane to which a distal end of the jerk vector belongs, which include: a driving status indicative of a phase “keeping up with a preceding vehicle” when involved in a vector area a1; a driving status indicative of a phase “overtaking two-wheeled vehicles” when involved in a vector area a2; a driving status indicative of a phase “finding an oncoming vehicle” when involved in a vector area a3; a driving status indicative of a phase “finding a preceding vehicle” when involved in a vector area a4; a driving status indicative of a phase “finding a two-wheeled vehicle” when involved in a vector area a5; and a driving status, indicative of a phase “going by an oncoming vehicle” when involved in a vector area a6.

Further, the difficult driving status judgment section 634 detects respective driving statuses of the vehicle involving: a driving status, indicative of a phase in which the own vehicle goes forward after a wait for a gap in a line of oncoming vehicles, under a condition where the right winker is flashing and the distal end of the jerk vector is involved in a vector area a7 on the x-y plane; and a driving status, indicative of a phase in which a pedestrian crossing a road is found, under a condition where the right winker is flashing and the distal end of the jerk vector is involved in a vector area a8 on the x-y plane.

Further, the difficult driving status judgment section 634 detects respective driving statuses of the vehicle involving: a driving status, indicative of a phase in which an oncoming vehicle is found, under a condition where the left winker is flashing and the distal end of the jerk vector is involved in a vector area a9 on the x-y plane; and a driving status, indicative of a phase in which an own vehicle goes forward after a wait for a gap in a line of pedestrians crossing a road, wherein the left winker is flashing and the distal end of the jerk vector is involved in a vector area a10 on the x-y plane.

Incidentally, among the driving statuses shown in FIG. 19, the driving statuses corresponding to the vector areas a1, a2, a6, a7 and a10 belong to driving statuses of “GO (JUDGE WITH AVAILABLE FOR DRIVE)” and the driving statuses corresponding to the vector areas a3, a4, a5, a8 and a9 belong to driving statuses of “RESPOND”.

In the meanwhile, during a halt of the vehicle, the difficult driving status judgment section 634 detects the driving statuses of the vehicle in accordance with the classification of the driving statuses indicated in FIG. 20.

More particularly, the classification, indicated in FIG. 20, is defined on the x-y plane and jerk vectors extend from an origin “O” on the x-y plane. Here, a positive direction on the x-axis (rightward) corresponds to a right direction with respect to a running direction of a vehicle and a positive direction on the y-axis (frontward) is aligned with the running direction of the vehicle.

As a result, the difficult driving status judgment section 634 detects respective driving statuses of the vehicle, depending on a vector area on the x-y plane to which a distal end of the jerk vector belongs, which include: a driving status, indicative of a phase “going forward after a halt due to traffic signals or traffic jams” when involved in a vector area b1; a driving status, indicative of a phase “starting from a rear of a parking vehicle” when involved in a vector area b2; a driving status, indicative of a phase “coming to a halt not to hit a two-wheeled vehicle when involved in a vector area b3; a driving status, indicative of a phase “coming to a halt due to traffic signals or traffic jams when involved in a vector area b4; a driving status, indicative of a phase “waiting a gap in a line of oncoming vehicles when involved in a vector area b5; and a driving status, indicative of a phase “going forward after a wait for a gap in a line of two-wheeled vehicles when involved in a vector area b6.

Further, the difficult driving status judgment section 634 detects respective driving statuses of the vehicle involving: a driving status, indicative of a phase in which the own vehicle goes forward after a wait for a gap in a line of oncoming vehicles, under a condition where the right winker is flashing and the distal end of the jerk vector is involved in a vector area b7 on the x-y plane; and a driving status, indicative of a phase in which an own vehicle waits for a gap in a line of pedestrians crossing a road, under a condition where the right winker is flashing and the distal end of the jerk vector is involved in a vector area b8 on the x-y plane.

Furthermore, the difficult driving status judgment section 634 detects respective driving statuses of the vehicle involving: a driving status, indicative of a phase in which the own vehicle waits for a gap in a line of oncoming vehicles, under a condition where the left winker is flashing and the distal end of the jerk vector is involved in a vector area b9 on the x-y plane; and a driving status, indicative of a phase in which the own vehicle goes forward after a wait for a gap in a line of pedestrians crossing a road, under a condition where the left winker is flashing and the distal end of the jerk vector is involved in a vector area b10 on the x-y plane.

Incidentally, among the driving statuses shown in FIG. 20, the driving statuses corresponding to the vector areas b1, b2, b6, b7 and b10 belong to driving statuses of “ASSESS” and the driving statuses corresponding to the vector areas b3, b4, b5, b8 and b9 belong to driving statuses of “WAIT”.

Then, the difficult driving status judgment section 634 sets a reference value associated with the detected driving status of the vehicle. Here, the reference value is set such that the remoter the vector area, corresponding to the driving status of the vehicle, from the y-axis shown in FIGS. 19 and 20, the greater will be the reference value. This is because a position of the vector area is associated with a running direction of the vehicle and the larger the displacement of the running direction of the vehicle with respect to a straight direction, the greater will be the probability for the running direction to become difficult for the driver. Also, a range less than the reference value are the reference range.

Then, the difficult driving status judgment section 634 makes comparison between the magnitude of the jerk vector and the reference value that is settled. As a result, only if the magnitude of the jerk vector exceeds the reference value, the difficult driving status judgment section 634 executes the driving status history registering operation described below.

[Driving Status History Registering Operation]

The difficult driving status judgment section 634 calculates the current date using the timer. Also, the difficult driving status judgment section 634 specifies a data area, associated with the driving status of the vehicle, from the data areas of the difficult driving status database 635 and discriminates whether driving status history data is registered in the specified data area.

Here, the difficult driving status database 635 has a data area for each driving status, like a judgment of “GO (JUDGE WITH AVAILABLE FOR DRIVE)” with respect to the phase “FINDING PRECEDING VEHICLE &FOLLOWING” as shown in FIG. 21. Driving status history data, which is generated by the difficult driving status judgment section 634, is registered in each data area.

Of the difficult driving status database 635 shown in FIG. 21, a data area, related to a row of “FINDING BIKE & BICYCLE & WAITING & OVERTAKING” and a line of “JUDGE WITH AVAILABLE FOR DRIVE”, correspond to a driving status (involved in the vector area a2) for the phase “overtaking two-wheeled vehicles” shown in FIG. 19. Also, “motorcycle and bicycle” are examples of “two-wheeled vehicles”.

As a result, if driving status history data is registered in the specified data area, the difficult driving status judgment section 634 retrieves the newest driving status history data from the specified data area. Then, the difficult driving status judgment section 634 increments a driving status detection frequency, represented by the newest driving status history data, by one to calculate the current driving status detection frequency.

If no driving status history data is registered in the specified data area, the difficult driving status judgment section 634 calculates the current driving status detection frequency as “1”.

Additionally, the difficult driving status judgment section 634 generates the current driving status history data, indicative of the calculated current date and driving status detection frequency, and registers these content in the specified data area of the difficult driving status database 635. That is, the driving status of the vehicle is registered in the difficult driving status database 635.

Accordingly, the date, which is registered in each data area, indicates a date on which the jerk square-sum exceeds the reference value. Also, the driving status detection frequency registered in each data area, that is, the frequency in which the driving status of the vehicle is registered in the difficult driving status database 635 indicates the number of times in which the magnitude of the jerk vector exceeds the reference value during a time period from time at which the operation is started by the driving status detection device 7 to a day indicated by the date corresponding to the driving status detection frequency.

That is, it can be said that the driving status registered in the difficult driving status database 635 is a driving status difficult for the driver. Also, it can be said that the greater the registering frequency, the more difficult will be the drive for the driver.

[Driving Status History Collating Operation]

Further, the difficult driving status judgment section 634 executes the driving status history collating operation as indicated below. That is, the difficult driving status judgment section 634 specifies a data area, associated with the driving status of the vehicle, from the data areas of the difficult driving status database 635.

Then, the difficult driving status judgment section 634 discriminates whether the number of times, in which driving status history data is registered in the specified data area, that is, the number of times in which driving status history data is registered in the difficult driving status database 635, exceeds the reference number of times.

As a result, only in an event that the number of times, in which driving status history data is registered in the difficult driving status database 635, exceeds the given reference number of times, the difficult driving status judgment section 634 detects a driving status of a vehicle as a difficult driving status for the driver. Then, an interrupt message display signal S17 is generated and outputted to the interrupt message preparing section 636.

The interrupt message preparing section 636 generates a safety drive data, raising awareness to the driver to perform safety drive, when applied with the interrupt message display signal from the difficult driving status judgment section 634, with the safety drive data being outputted to the display device 14. The display device 14 provides a display of a content of the safety drive data, delivered from the interrupt message preparing section 636, over a screen.

Next, the above-described operation is described in time series with reference to FIG. 22.

In step S701 shown in FIG. 22, the vehicle speed and running direction detector 611 detects a running speed of a vehicle, a flashing condition of a winker and a vehicle speed. Then, the vehicle speed and running direction detector 611 generates a running direction behavior signal related to the running of the vehicle, the flashing condition of the winker and the vehicle speed. Consecutively, the vehicle speed and running direction detector 611 outputs the resulting running direction behavior signal to the vehicle speed preprocessing section 631.

Further, the lateral-direction behavior detector 612 detects a lateral-G. Consecutively, the lateral-direction behavior detector 612 generates a lateral-G signal, related to the detected lateral-G, which in turn is outputted to the lateral-direction-behavior preprocessing section 632.

In succeeding step S702, the vehicle speed preprocessing section 631 calculates a jerk value, related to the vehicle speed, based on the vehicle speed delivered from the vehicle speed and running direction detector 611. Then, the vehicle speed preprocessing section 631 generates a jerk signal, related to the calculated jerk value, which in turn is outputted to the resultant vector calculating section 633.

Further, the lateral-direction-behavior preprocessing section 632 generates a lateral-G jerk value, related to the lateral-G, based on the lateral-G signal delivered from the lateral-direction behavior detector 612. Consecutively, the lateral-direction-behavior preprocessing section 632 generates a lateral-G jerk signal, related to the calculated lateral-G jerk value, which in turn is outputted to the resultant vector calculating section 633.

In subsequent step S703, the resultant vector calculating section 633 calculates a jerk vector based on the jerk signal and the lateral-G jerk signal applied from the vehicle speed preprocessing section 631 and the lateral-direction-behavior preprocessing section 632, respectively, for a given time interval. Then, the resultant vector calculating section 633 generates a jerk vector signal, related to the calculated jerk vector, the running of the vehicle and the flashing condition of the winker, which in turn is outputted to difficult driving status judgment section 634.

In consecutive step S704, the difficult driving status judgment section 634 detects a driving status of the vehicle by executing the above operations based on the jerk vector signal delivered from the resultant vector calculating section 633. Then, the difficult driving status judgment section 634 sets a reference value associated with the detected driving status of the vehicle. Subsequently, the difficult driving status judgment section 634 makes comparison between the magnitude of the jerk vector and the reference value that is settled. As a result, if the magnitude of the jerk vector exceeds the reference value, the operation proceeds to step S705 and if the magnitude of the jerk vector is less than the reference value, the operation proceeds to step S706.

With the operation routed to step S705, the difficult driving status judgment section 634 calculates the current date using the timer. Then, the difficult driving status judgment section 634 specifies a data area, associated with the driving status of the vehicle, from the data areas of the difficult driving status database 635 to discriminate whether driving status history data is registered in the specified data area.

As a result, if driving status history data is registered in the specified data area, the difficult driving status judgment section 634 retrieves the newest driving status history data from the specified data area. Then, the difficult driving status judgment section 634 increments the driving status detection frequency, represented by the retrieved newest driving status history data, by one to calculate the current driving status detection frequency.

On the contrary, if no driving status history data is registered in the specified data area, the difficult driving status judgment section 634 calculates the current driving status detection frequency as “1”.

The difficult driving status judgment section 634 generates current driving status history data, indicative of the calculated current date and driving status detection frequency, and registers these contents in the specified data area of the data areas of the difficult driving status database 635. Thereafter, the operation is routed back to step S706.

Next, in step S706, the difficult driving status judgment section 634 specifies a data area, associated with the driving status of the vehicle detected in step S704, from the data areas of the difficult driving status database 635.

In subsequent step S707, the difficult driving status judgment section 634 discriminates whether the number of times, in which driving status history data is registered in the specified data area, that is, the number of times in which driving status history data is registered in the difficult driving status database 635, exceeds the reference number of times.

As a result, if the number of times, in which driving status history data is registered in the difficult driving status database 635, exceeds a given reference number of times, the operation proceeds to step S708 and if the newest driving status detection frequency becomes less than the reference number of times, the operation is routed back to step S701.

In next step S708, the difficult driving status judgment section 634 detects the driving status of the vehicle, detected in step S704, as a difficult driving status for the driver. Then, the difficult driving status judgment section 634 generates an interrupt message display signal, which is outputted to the interrupt message preparing section 636. Then, the interrupt message preparing section 636 generates a safety drive data, raising awareness to the driver to perform safety drive, when applied with the interrupt message display signal from the difficult driving status judgment section 634, with the safety drive data being outputted to the display device 14.

In succeeding step S709, the display device 14 provides a display of a content of the safety drive data, delivered from the interrupt message preparing section 636, over a screen. Thereafter, the operation proceeds to step S701. As set forth above, the presently filed embodiment has not only the same advantageous effects as those of the first embodiment but also additional advantageous effects as described below.

That is, the driving status detection device 7 detects the vehicle speed and lateral-G and calculates the jerk conversion value based on the detected vehicle speed and lateral-G. Accordingly, the driving status detection device 7 is able to calculate a jerk conversion value, also associated with a behavior of the vehicle in a lateral direction thereof, that is, a jerk conversion value that reflects the steering. More particularly, the driving status detection device 7 is able to calculate a jerk vector as a jerk conversion value. Therefore, the driving status detection device 7 is able to calculate the jerk conversion value in a more detail fashion.

Further, since the driving status detection device 7 detects the driving status of the vehicle depending on the calculated jerk vector, a driving status that reflects the steering can be detected. In particular, the driving status detection device 7 is able to detect the driving statuses shown in FIGS. 19 and 20.

Furthermore, since the driving status detection device 7 is able to detect the driving status, in which the magnitude of the jerk vector exceeds the reference value, as the difficult driving status for the driver, the difficult driving status for the driver can be detected from the driving statuses shown in FIGS. 19 and 20. Moreover, the driving status detection device 7 detects the driving status, in which the frequency, registered in the difficult driving status database 635, exceeds the reference frequency, as the difficult driving status for the driver. Accordingly, the driving status detection device 7 is able to detect the difficult driving status for the driver in a more reliable manner.

Next, a modified form of the presently filed embodiment will be described below.

In the modified form, the lateral-direction behavior detector 612 detects a yaw rate, instead of lateral-G of the vehicle, as a behavior of the vehicle. The lateral-direction behavior detector 612 generates a yaw rate signal, related to the detected yaw rate, which in turn is outputted to the lateral-direction behavior preprocessing section 632.

The lateral-direction behavior preprocessing section 632 calculates a yaw rate jerk value, related to the yaw rate, and based on the yaw rate signal delivered from the lateral-direction behavior detector 612. As used herein, the term “yaw rate jerk value” refers to a value obtained by differentiating the yaw rate in second order. Then, a yaw rate jerk signal, related to the calculated yaw rate jerk value, is generated and outputted to the resultant vector calculating section 633.

The resultant vector calculating section 633 calculates a jerk vector (jerk conversion value) based on the jerk signal and the yaw rate jerk signal applied from the vehicle sped detector 631 and the lateral behavior preprocessing section 632 for a certain time interval.

Here, the magnitude SJJY (tn) of the jerk vector at a certain time tn is a sum obtained by adding the results of a square J2 of the jerk value and a square JY2 of the yaw rate jerk value, which are counted from time t (n−m) to time (n+m), respectively, and expressed in a formula described below wherein n and m represent positive integers.

$$\begin{matrix}SJJY ( tn ) = {J}^{2} ( t ( n - m ) ) + {JY}^{2} ( t ( n - m ) ) + {J}^{2} ( t ( n - m + 1 ) ) + \\ {JY}^{2} ( t ( n - m + 1 ) ) + … + {J}^{2} ( t ( n + m ) ) + {JY}^{2} ( t ( n + m ) ) \\ = Σ ( {J}^{2} ( t = t ( n + m ) ) … t ( n + m ) ) + \\ {JY}^{2} ( t = t ( n - m ) … t ( n + m ) )\end{matrix}$$

In this connection, a directionθY of the jerk vector at the certain time tn is expressed by a formula (5), as described below, under circumstances where the vehicle speed is increasing (that is, during acceleration) and a direction of the yaw rate is oriented rightward, and expressed by a formula (6), as described below, under circumstances where the vehicle speed is decreasing (that is, during deceleration) and the direction of the yaw rate is oriented leftward. Also, the directionθY of the jerk vector at certain time tn is expressed by a formula (7), as described below, under circumstances where the vehicle speed is decreasing (that is, during deceleration) and the direction of the yaw rate is oriented rightward, and expressed by a formula (8), as described below, under circumstances where the vehicle speed is decelerating and the direction of the yaw rate is oriented leftward. Incidentally, “arctan” in each formula represents an inverse function of “tan”.
θY=arctan(ΣJ²/ΣJY²) (5)
θY=arctan(−ΣJ²/ΣJY²) (6)
θY=−arctan(ΣJ²/ΣJY²) (7)
θY=−arctan(−ΣJ²/ΣJY²) (8)

Then, the resultant vector calculating section 633 generates a jerk vector signal, related to the calculated jerk vector, the vehicle speed and the flashing condition of the winker, which in turn is outputted to the difficult driving status judgment section 634. The other component parts execute the same operations as those described above.

Even this modified form has the same advantageous effects as those of the presently filed seventh embodiment. Also, with this modified form, the jerk conversion value is calculated based on the yaw rate of the vehicle and, so, it becomes possible to calculate the jerk conversion value that more precisely reflects the steering.

Incidentally, with this modified form, the jerk vector may be calculated using an absolute value of the jerk value and an absolute value of the lateral-G jerk value in place of the square of the jerk value and the square of the yaw rate jerk value.

### Eighth Embodiment

Now, a driving status detection device and its related method of an eighth embodiment according to the present invention are described in detail.

The presently filed embodiment has a structure in which, under circumstances where a jerk conversion value, resulting from a so-called jerk value related to a speed of a vehicle, exceeds a reference range, a risk occurrence scene with a high degree of risk for a driver is detected, and such a structure differs from those of the embodiments 1 to 7. Hereunder, with an attention focused on such a difference, the same component parts bear like reference numerals and description is made in a suitably omitted or simplified form.

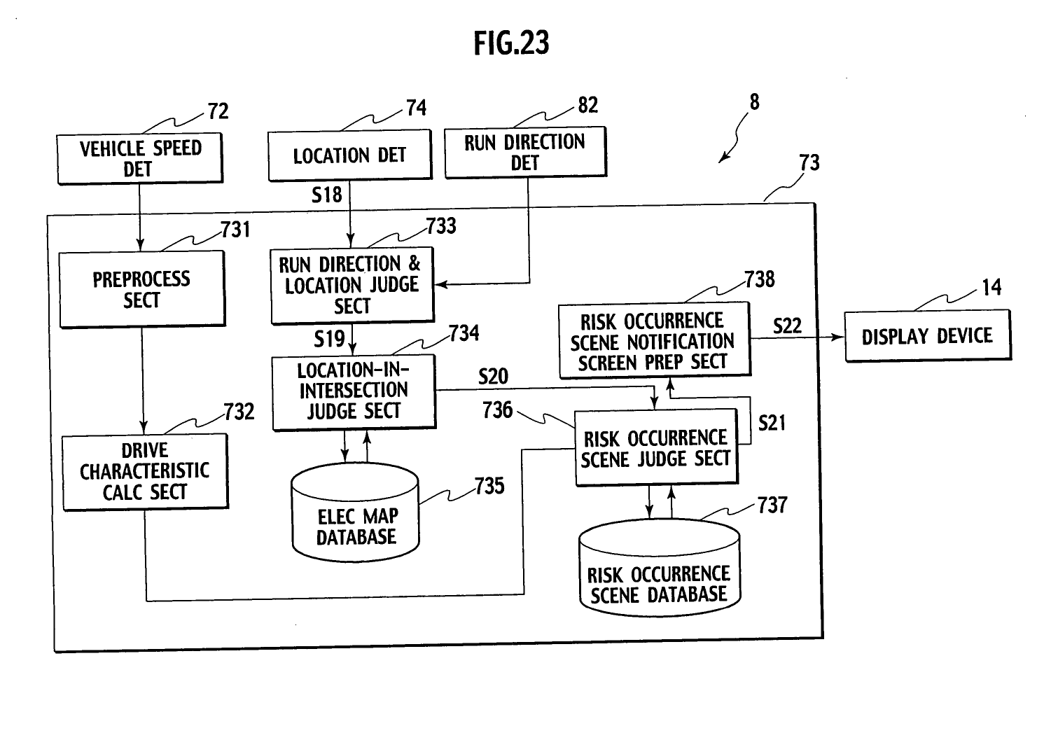

Referring to FIGS. 23 to 26, the driving status detection device and related method are described more in detail.

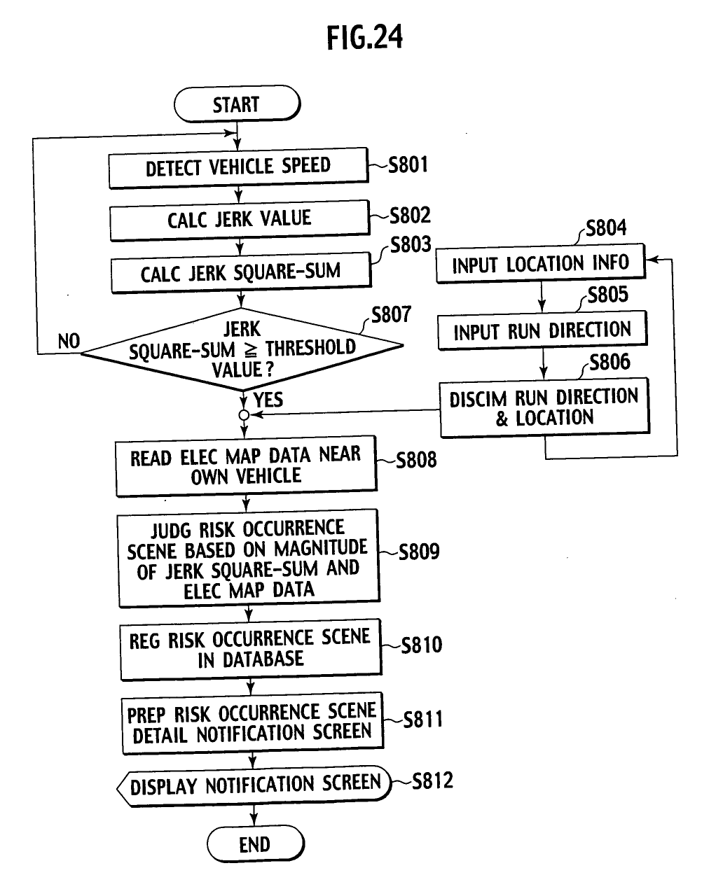

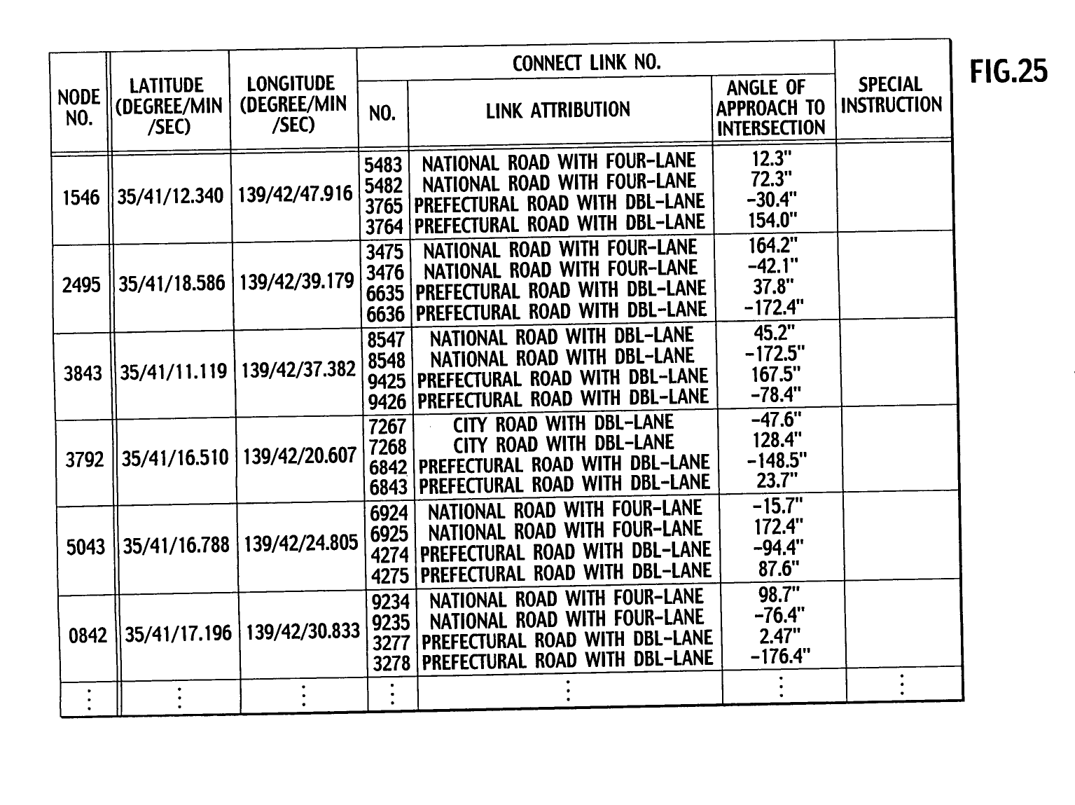

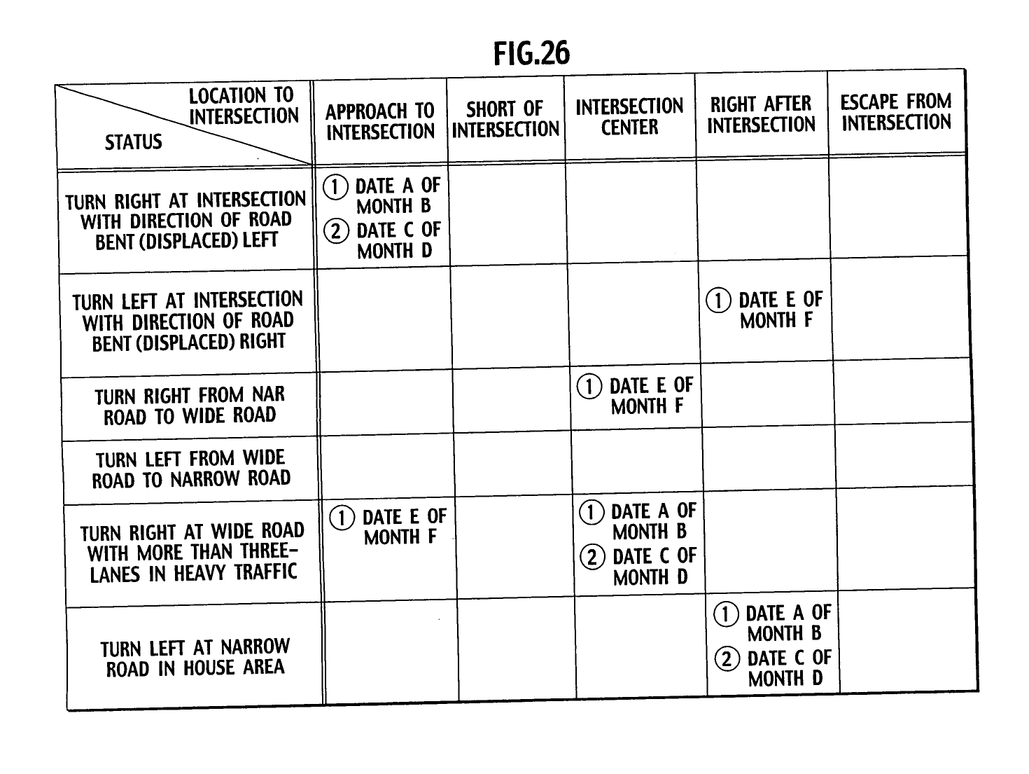

FIG. 23 is a block diagram showing a structure of the driving status detection device of the presently filed embodiment; FIG. 24 is a flowchart illustrating a basic sequence of operations of the driving status detection device of the presently filed embodiment; FIG. 25 is a view illustrating one example of an electronic map data stored in an electronic map database of the driving status detection device of the presently filed embodiment; and FIG. 26 is a view illustrating one example of risk occurrence scene data stored in a risk occurrence scene database of the driving status detection device of the presently filed embodiment.

As shown in FIG. 23, the driving status detection device 8, which is installed on a vehicle, is comprised of a vehicle speed detector 72, a location detector 74, a running direction detector 82, an on-vehicle computer 73 and a display device 14. The on-vehicle computer 73 includes a preprocessing section 731 that executes preprocessing operation upon receipt of a vehicle speed value detected by the vehicle speed detector 72, a driving characteristic calculating section 732 that calculates a jerk square sum, a running direction and location judgment section 733 that judges a running direction and location of the vehicle based on locating information of the vehicle detected by the location detector 74 and a running direction signal detected by the running direction detector 82, a location-in-intersection judgment section 734 that judges a location of the vehicle inside an intersection, an electronic map database 735 that stores electronic map data in which information, related to locations and shapes of roads and intersections, are registered, a risk occurrence judgment section 736 that judges risk occurrence scenes in accordance with the jerk square sums and vehicle locations inside the intersections, a risk occurrence scene database 737 that stores data related to detected risk occurrence scenes, a risk occurrence scene notification screen preparing section 738 that prepares a screen to provide a driver with a notification that a risk occurrence scene is detected, and a display device 14 that provides a display of a risk occurrence scene notification screen.

Here, the vehicle speed detector 72 may include a wheel speed sensor of the vehicle, like in the respective embodiments set forth above, and outputs a vehicle speed signal, with a value associated with the vehicle speed, which in turn is outputted to the preprocessing section 731 of the driving status detection device 8.

The location detector 74 may include a navigation locator that specifies a current location of the vehicle, detected by a GPS (Global Positioning System) device for positional detection, on map data and outputs a location signal S18, having a value associated with location information of the vehicle, with the outputted location signal being inputted to the running direction and location judgment section 733 of the driving status detection device 8.

The running direction detector 82 may include a steering angle sensor, which detects a winker lever for operating a winker of the vehicle, and a cutting angle of a steering wheel, and generates a running direction signal forming a sensor signal indicative of the running direction of the vehicle. The outputted running direction signal is inputted to the running direction and location judgment section 733.

The electronic map database 735 stores electronic map data related to map structural components such as seas, rivers, railways and roads. A configuration of data, related to each structural component, is registered using a figure such as a straight line and polygon, with a position of each apex of the figure being plotted in terms of a map coordinate such as a latitude, a longitude or a form with their equivalents. Electronic map data of the electronic map database 35 is available to be freely retrieved.

Next, a basic sequence of operations of detecting a driving status in the driving status detection device of the presently filed embodiment is described with reference to FIG. 24.

In step S801 shown in FIG. 24, first, the vehicle speed detector 72 detects a speed of a vehicle and, in consecutive step 802, the preprocessing section 731 calculates a jerk value on the basis of the detected vehicle speed.

In succeeding step S803, the preprocessing section 731 calculates a jerk square sum SJ (tn) at a certain time tn and the operation proceeds to step S807. Also, in place of using the jerk square, an absolute value of the jerk value may be employed.

The reason why the square sum of the jerk value is calculated in such a way resides in that the jerk value represents a rate of change in acceleration and, hence, the presence of operations, such as sudden braking or abrupt steering, the jerk value takes a large value. Accordingly, under circumstances where there is a high degree of risk like in the risk occurrence scene, calculating the square sum of the jerk value within a given time interval results in an increased value and, hence, if a given threshold value (reference value) is preliminarily determined to allow judgment to be made such that when the square sum of the jerk value exceeds such threshold value, there is a situation with a high risk, the risk occurrence scene can be detected.

In succeeding step S807, the driving characteristic calculating section 732 discriminates whether the jerk square sum, calculated in step S803, exceeds the threshold value and, if greater than the threshold value, the operation proceeds to step S808 whereas, if less than the threshold value, the operation is routed back to step S801.

In the meanwhile, in step S804, location information of the vehicle, detected by the location detector 74, is inputted to the running direction and location judgment section 733 and, in subsequent step S805, the running direction signal, indicative of the running direction of the vehicle detected by the running direction detector 82, is also inputted to the running direction and location judgment section 733.

In succeeding step S806, the running direction and location judgment section 733 judges the location and the running direction of the vehicle based on location information and the running direction signal, which are inputted, and the operation proceeds to step S808.

Next, in step S808, the location-in-intersection judgment section 734 accesses electronic map database 735 using the location and the running direction of the vehicle, detected in step S806, as a guide, and retrieves electronic map data in the vicinity of the vehicle.

Here, one example of electronic map data is shown in FIG. 25.

As shown in FIG. 25, electronic map data is registered with a node number, a latitude and longitude designating locations at intersections, and link numbers for connections. The connection link has registration about road information, which includes link numbers, a link attribute such, as road levels (national roads and prefectural roads) and the number of lanes, and an angle of approach to the intersection.

If electronic map data is retrieved in step S808, the location-in-intersection judgment section 734 delivers a resulting data signal S20 to the risk occurrence judgment section 736. In consecutive step S809, the risk occurrence judgment section 736 judges and detects the presence of a risk occurrence scene, depending on the location and running direction of the vehicle inside the intersections when the jerk square sum exceeds a given threshold value, on the basis of retrieved electronic map data, thereby estimating an object that causes the risk occurrence scene to take place. If the risk occurrence scene at right-turn is found, this allows estimation that an oncoming vehicle is the relevant object.

In next step S810, the detected risk occurrence scene is stored in the risk occurrence scene database 737.

Here, one example of risk occurrence scene data stored in the risk occurrence scene database 737 is exemplarily shown in FIG. 26.

As shown in FIG. 26, risk occurrence scene data is arranged so as to enable each risk occurrence scene to be registered based on statuses at the intersection and locations associated with the intersection. The statuses at the intersection include statuses such as a right-turn at the intersection, a left-turn at the intersection and a right-turn from a narrow road to a wide road. The locations associated with the intersection include an approach to the intersection, an area shortly before the intersection and an intersection center. Additionally, a date on which the risk occurrence scene occurs is also registered.

Thus, in step S810, if the risk occurrence judgment section 736 registers the risk occurrence scene in the risk occurrence scene database 737, the risk occurrence judgment section 736 delivers a registration completion signal S21 to the risk occurrence scene notification screen preparing section 738.

In succeeding step S811, the risk occurrence scene notification screen preparing section 738 prepares a notification screen for notifying the driver with a detail of the risk occurrence scene and, in step S812, allows the display device 14 to provide a display of the notification screen to notify the driver with a detail of the risk occurrence scene while further providing a message raising awareness to the driver to pay attention to a vicinity, whereupon the current operation is terminated.

As set forth above, with the presently filed embodiment, the risk occurrence scene, such as confused operation caused by delayed finding of an obstacle and an avoidance of the obstacle, can be detected and this enables the driver to use the detected risk occurrence scene as a guide for an availability in subsequent drive.

Further, upon detection of the risk occurrence scene, a message is provided to the driver to raise awareness for paying an attention to the surroundings, thereby alerting the driver to avert a risk.

Furthermore, with the driving status detection device of the presently filed embodiment, since electronic map data is used as a guide to detect an occurrence position of the risk occurrence scene for thereby estimating an object by which the risk occurrence scene is provided, a detail of the risk occurrence scene can be detected and this is used for the driver to be helpful in subsequent drive.

### Ninth Embodiment

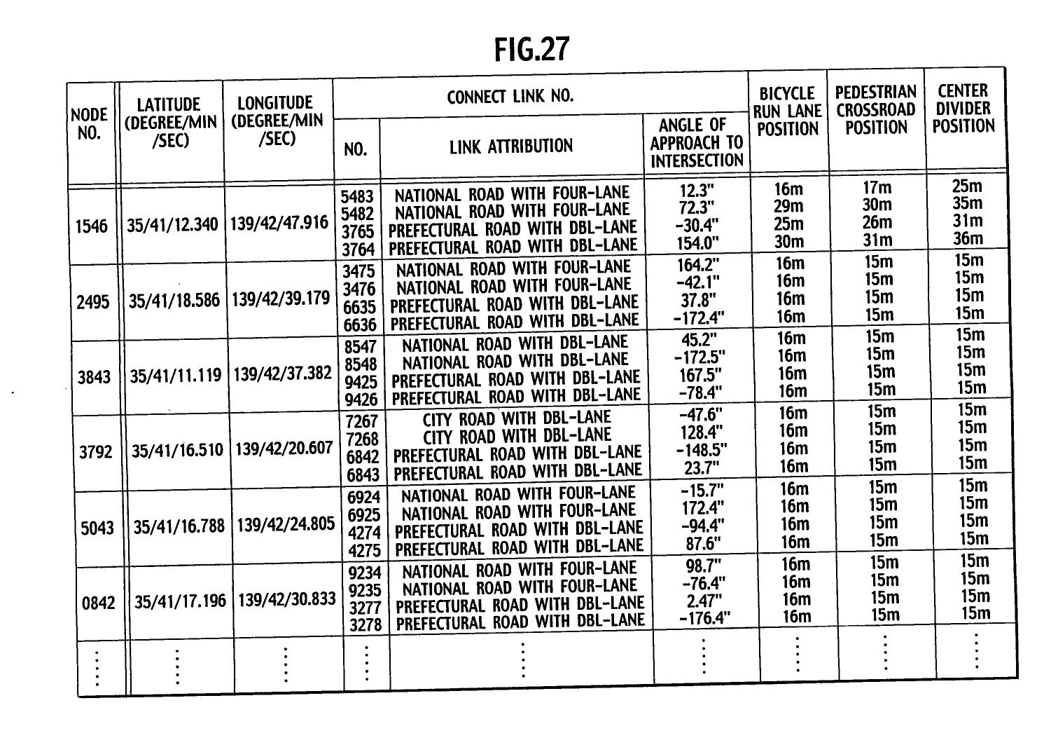

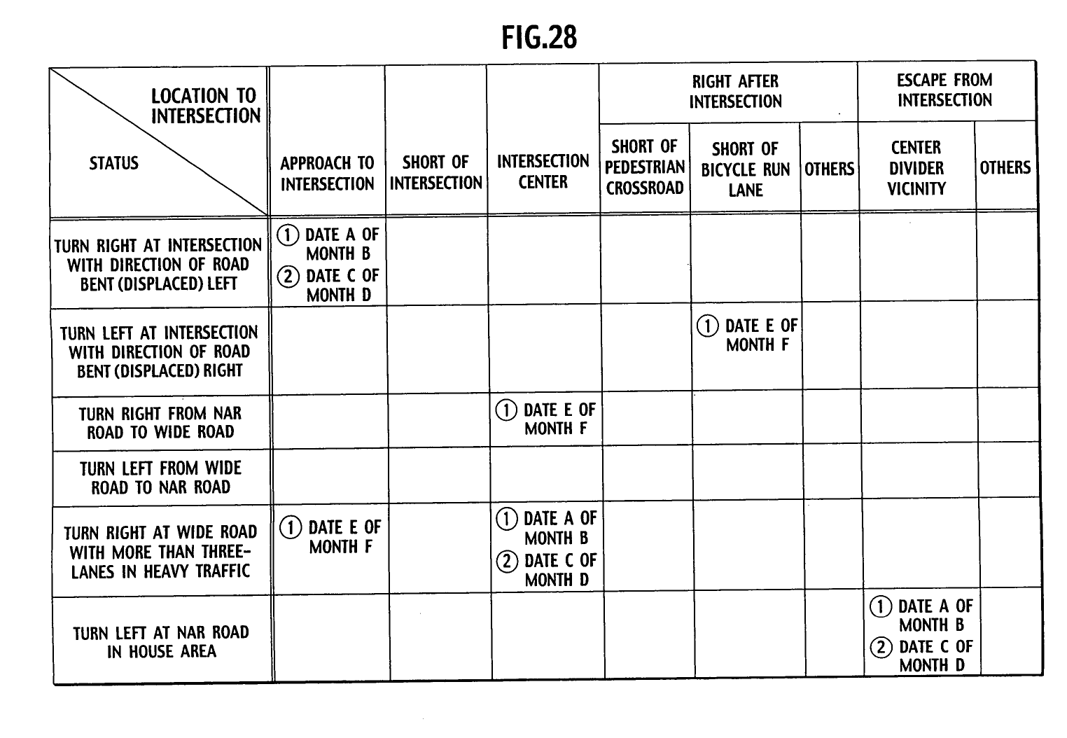

Now, a driving status detection device and its related method of a ninth embodiment according to the present invention are described in detail with reference to FIGS. 27 and 28.

FIG. 27 is a view illustrating one example of electronic map data stored in an electronic map database of the driving status detection device of the ninth embodiment; and FIG. 28 is a view illustrating one example of risk occurrence scene data stored in a risk occurrence scene database of the driving status detection device of the presently filed embodiment.

The driving status detection device of the presently filed embodiment differs from that of the eighth embodiment in difference in contents of electronic map data and risk occurrence scene data. Hereunder, with an attention focused on such a difference, the same component parts bear like reference numerals and description is made in a suitably omitted or simplified form.

In particular, as shown in FIG. 27, electronic map data is registered with a node number, a latitude and longitude designating locations at intersections, and connection link numbers and, in addition thereto, further includes a bicycle running lane position, a pedestrian crossing position and a center divider position.

Then, the driving status detection device estimates that when a vehicle is located in the vicinity of a pedestrian crossing under a condition where a jerk square sum exceeds a given threshold value by referring to electronic map data, there is a risk occurrence scene related to a pedestrian.

Similarly, it is estimated such that when the vehicle is located in the vicinity of the bicycle running lane under a condition where the jerk square sum exceeds the given threshold value, there is a risk occurrence scene due to a bicycle and when the vehicle is located in the vicinities of the center divider lane and an oncoming vehicle lane under a condition where the jerk square sum exceeds the given threshold value, there is a risk occurrence scene related to an oncoming vehicle at a right-turn.

The driving status detection device allows the detected risk occurrence scene to be registered in the risk occurrence scene database 737.

Further, as shown in FIG. 28, risk occurrence scene data in the presently filed embodiment is enabled to allow each risk occurrence scene to be registered based a status of an intersection and locations with respect to the intersection. Examples of the status of the intersection include statuses such as a right-turn at the intersection, a left-turn at the intersection and a right-turn from a narrow road to a wide road. Examples of the locations with respect to the intersection include “APPROACH TO INTERSECTION”, “AREA SHORTLY BEFORE INTERSECTION” and “INTERSECTION CENTER”. In addition to these, risk occurrence scene data of the presently filed embodiment has an item of “JUST BEHIND INTERSECTION”, which contains “SHORTLY BEFORE PEDESTRIAN CROSSING”, “SHORTLY BEFORE BICYCLE RUNNING LANE” and an item of “Others”, and an item of “ESCAPE FROM INTERSECTION” that includes “CENTER DIVIDER VICINITY” and an item of “Others”. Additionally, a date on which the risk occurrence scene arises is also registered.

As set forth above, with the presently filed embodiment, the pedestrian crossing location and the bicycle running lane location are registered in electronic map data and it is estimated that when a location at which the risk occurrence scene occurs lies in a pedestrian crossing vicinity or a bicycle running lane vicinity, a pedestrian or a bicycle forms an occurrence object for the risk occurrence scene to arise and, hence, a detail of the risk occurrence scene can be detected to allow this detail to be made helpful for a driver in subsequent drive.

Further, traffic lane locations and center divider lane locations are registered in electronic map data and it is estimated that when an occurrence location of the risk occurrence scene lies in vicinities of an oncoming vehicle lane or a center divider lane, an oncoming vehicle at a right-turn forms an occurrence object for the risk occurrence scene to arise and, hence, a detail of the risk occurrence scene can be detected to allow this detail to be made helpful for the driver in subsequent drive.

### Tenth Embodiment

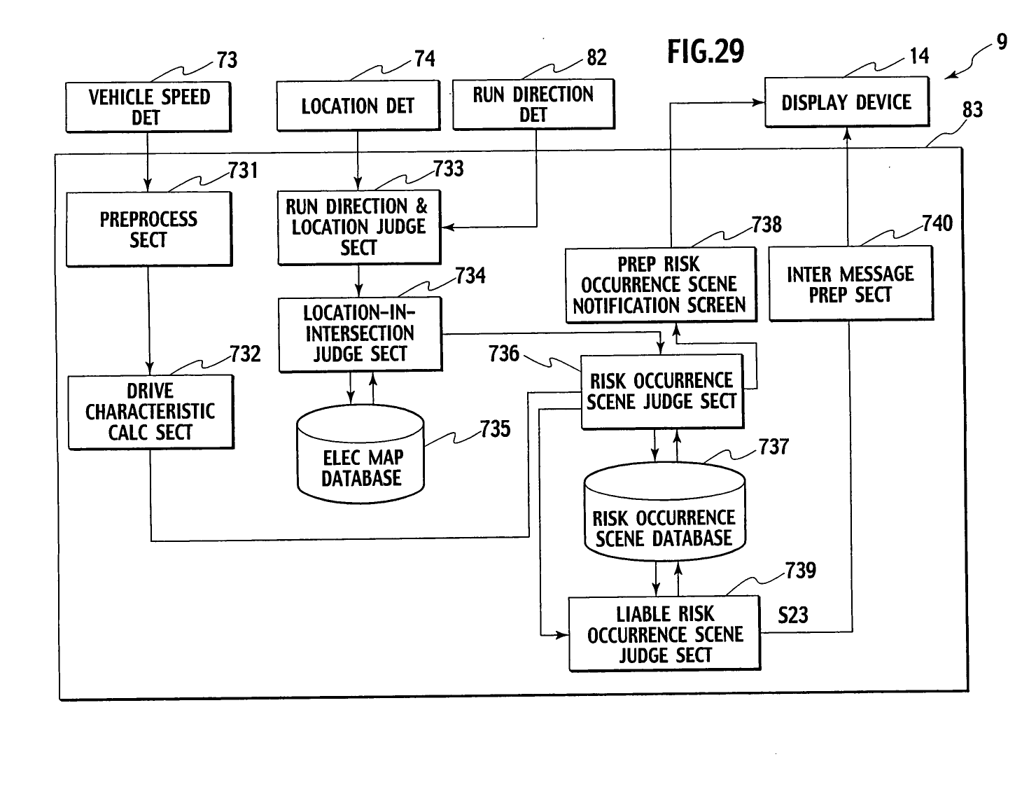

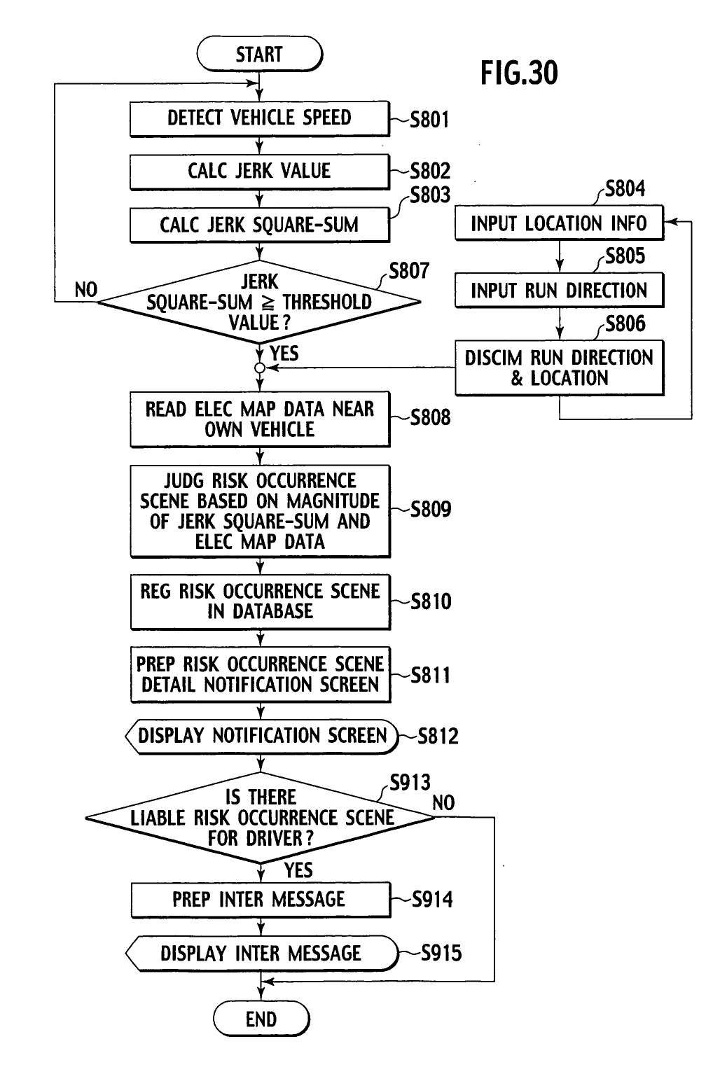

Now, a driving status detection device and its related method of a tenth embodiment according to the present invention are described in detail with reference to FIGS. 29 and 30.

FIG. 29 is a block diagram illustrating a structure of the driving status detection device of the presently filed embodiment; and FIG. 30 is a flowchart for illustrating a basic sequence of operations of the driving status detection device of the presently filed embodiment.

The driving status detection device of the presently filed embodiment differs from that of the eighth embodiment mainly in that the on-vehicle computer 83 incorporates a liable risk occurrence judgment section 739 for discriminating a liable risk occurrence scene of a driver based on risk occurrence data and an interrupt message preparing section 740 by which an interrupt message is prepared when the liable risk occurrence for the driver is detected. Hereunder, with an attention focused on such a difference, the same component parts bear like reference numerals and description is made in a suitably omitted or simplified form.

As shown in FIG. 29, the driving status detection device 9 is comprised of a preprocessing section 731 that executes preprocessing operation upon receipt of a vehicle speed value detected by a vehicle speed detector 73, a driving characteristic calculating section 732 that calculates a jerk square sum, a running direction and location judgment section 733 that judges a running direction and location of the vehicle based on location information of the vehicle detected by a location detector 74 and a running direction signal detected by a running direction detector 82, a location-in-intersection judgment section 734 that judges a location of the vehicle inside an intersection, an electronic map database 735 that stores electronic map data registered with information related to locations and shapes of roads and intersections, a risk occurrence judgment section 736 that judges risk occurrence scenes in accordance with the jerk square sum and vehicle locations inside the intersections, a risk occurrence scene database 737 that stores data related to detected risk occurrence scenes, a risk occurrence scene notification screen preparing section 738 that prepares a screen to provide a driver with a notification that a risk occurrence scene is detected, a display device 14 that provides a display of a risk occurrence scene notification screen, a liable risk occurrence scene judgment section 739 for discriminating a liable risk occurrence scene for a driver based on risk occurrence data, and an interrupt message preparing section 740 that prepares an interrupt message when the liable risk occurrence scene for the driver is detected.

The liable risk occurrence scene judgment section 739 judges and detects that, when the same risk occurrence scenes as those detected are already registered in the risk occurrence scene database 737 more than given number of times, there is a liable risk occurrence scene for the driver, thereby delivering a detection signal 23 to the interrupt message preparing section 14.

Upon detection of such a risk occurrence scene liable for the driver to encounter, the interrupt message preparing section 14 prepares an interrupt message notifying the driver with information that the driver has often encountered such a risk occurrence scene.

Next, a basic sequence of operations of the driving status detection device of the presently filed embodiment is described with reference to FIG. 30. Also, the operations from step S801 to step 812 are identical to those of the ninth embodiment and, here, the sequence will be described with reference to operations subsequent to step S913.

In step S812 shown in FIG. 30, the risk occurrence scene detailed notification screen is displayed and, in consecutive step S913, the risk occurrence scene judgment section 736 accesses risk occurrence scene database 737 and discriminates whether the risk occurrence scene happening this time is a liable risk occurrence scene for the driver. Such a discrimination method is arranged such that when the risk occurrence scenes, happening under the same status and the same location as those related to the same intersection, are already registered in risk occurrence scene data more than given number of times, there is a liable risk occurrence scene for the driver.

In succeeding step S913, if discrimination is made that there is no liable risk occurrence scene for the driver, the current operation is terminated. In contrast, if discrimination is made in step S913 that there is a liable risk occurrence scene for the driver, the liable risk occurrence scene judgment section 736 delivers a signal S23 to the interrupt message preparing section 740, and the operation proceeds to step S914.

With the operation routed to step S914, the interrupt message preparing section 740 prepares an interrupt message, which is displayed over the display device 14 in consecutive step S915 to provide the driver with a notice of the presence of the liable risk occurrence scene frequently encountered by the driver whereupon the current operation is terminated.

As set forth above, with the presently filed embodiment, since the driving status detection device detects the risk occurrence scene, liable for the driver to encounter, based on risk occurrence scene data registered as a history, to allow the liable risk occurrence scene to be notified to the driver, making it possible for the liable risk occurrence scene to be helpful for the driver in subsequent drive.

The entire content of a Patent Application No. TOKUGAN 2004-008028 with a filing date of Jan. 15, 2004 in Japan, the entire content of a Patent Application No. TOKUGAN 2004-029222 with a filing date of Feb. 5, 2004 in Japan and the entire content of a Patent Application No. TOKUGAN 2004-029773 with a filing date of Feb. 5, 2004 in Japan are hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

1. A driving status detection device detecting a characteristic driving status during a drive of a vehicle, comprising:
a vehicle speed detector detecting a vehicle speed;
a processing section calculating a differentiated value of second order of the vehicle speed within a given time interval; and
a detecting section detecting a risk occurrence scene that is a driving status at a high risk for a driver based on the differentiated value of second order of the vehicle speed.

2. The driving status detection device according to claim 1, wherein the preprocessing section calculates a jerk conversion value based on a jerk value that is the differentiated value of second order of the vehicle speed, and the detecting section detects a distraction of the driver when the jerk conversion value exceeds a reference range set in compliance with the jerk conversion value.

3. The driving status detection device according to claim 2, further comprising a provider section providing an occupant of a vehicle with interrupt data, raising awareness to interrupt operation of an on-vehicle unit, when the detecting section detects the distraction.

4. The driving status detection device according to claim 2, further comprising an operation inhibiting section disabling operation of the on-vehicle unit when the detecting section detects the distraction.

5. The driving status detection device according to claim 4, wherein the operation inhibiting section disables the operation of the on-vehicle unit upon an elapse of an operation permit time after the distraction is detected.

6. The driving status detection device according to claim 4, wherein after disabling the operation of the on-vehicle unit, the operation inhibiting section permits the operation of the on-vehicle unit upon an elapse of an operation inhibit time after the jerk conversion value falls in the reference range.

7. The driving status detection device according to claim 4, wherein after disabling the operation of the on-vehicle unit, the operation inhibiting section permits the operation of the on-vehicle unit upon stopping a vehicle.

8. The driving status detection device according to claim 4, further comprising:
a database; and
an operation object detecting section detecting the on-vehicle unit that is an object to be operated by the driver;
wherein when both the distraction and the on-vehicle unit are detected, the detecting section registers the detected on-vehicle unit in the database and detects the registered on-vehicle unit as a difficult on-vehicle unit that the driver encounters a difficulty to operate.

9. The driving status detection device according to claim 8, wherein the operation inhibiting section disables operation of the detected difficult on-vehicle unit.

10. The driving status detection device according to claim 8, wherein the operation object detecting section detects operation executed by the driver on the on-vehicle unit and, when both the distraction and the operation are detected, the detecting section registers the detected operation in the database and detects the registered operation as a difficult operation that is difficult for the driver to execute.

11. The driving status detection device according to claim 10, wherein the operation inhibiting section disables the detected difficult operation.

12. The driving status detection device according to claim 2, wherein the processing section calculates the jerk value when the driver operates the on-vehicle unit.

13. The driving status detection device according to claim 2, wherein the jerk value conversion value includes an absolute value of the jerk value or an integrated value of a square of the jerk value.

14. The driving status detection device according to claim 1, wherein the processing section calculates a jerk conversion value based on a jerk value that is the differentiated value of second order of the vehicle speed, and the detecting section detects a driving status difficult for the driver when the jerk conversion value exceeds a reference range set in compliance with the jerk conversion value.

15. The driving status detection device according to claim 14, further comprising a provider section providing an occupant of a vehicle with safety drive data, raising awareness to perform safety drive when the detecting section detects the difficult driving status.

16. The driving status detection device according to claim 14, wherein the processing section detects the jerk conversion value additionally using a yaw rate of a vehicle.

17. The driving status detection device according to claim 14, wherein the processing section detects the jerk conversion value additionally using lateral acceleration of a vehicle.

18. The driving status detection device according to claim 14, further comprising a database,
wherein the detecting section registers a vehicle driving status in the database, when the jerk conversion value exceeds the reference range, and detects the vehicle driving status, whose number of times registered in the database exceeds a given reference number of times, as the difficult driving status.

19. The driving status detection device according to claim 14, further comprising a running direction detector that detects a vehicle running direction as a vehicle driving status,
wherein the detecting section detects a running direction difficult for the driver when the jerk conversion value exceeds a reference range set depending on the jerk conversion value.

20. The driving status detection device according to claim 14, wherein the jerk conversion value includes a jerk vector.

21. The driving status detection device according to claim 20, wherein the detecting section detects a driving status with respect to a preceding vehicle as the vehicle driving status when a vehicle running and a direction of the jerk vector is oriented forward or rearward.

22. The driving status detection device according to claim 20, wherein the detecting section detects a driving status with respect to a two wheeled vehicle as the vehicle driving status when a vehicle running and a direction of the jerk vector is oriented rightward and forward or leftward and rearward.

23. The driving status detection device according to claim 20, wherein the detecting section detects a driving status with respect to an oncoming vehicle as the vehicle driving status when a vehicle running and a direction of the jerk vector is oriented leftward and forward or rightward and rearward.

24. The driving status detection device according to claim 20, wherein the detecting section detects a driving status with respect to an oncoming vehicle as the vehicle driving status when a winker of a vehicle is flashing and a direction of the jerk vector is oriented rightward and forward or leftward and rearward.

25. The driving status detection device according to claim 20, wherein the detecting section detects a driving status with respect to a pedestrian crossing person as the vehicle driving status when a winker of a vehicle is flashing and a direction of the jerk vector is oriented leftward and forward or rightward and rearward.

26. The driving status detection device according to claim 1, wherein when the risk occurrence scene is detected, a message is provided to the driver to raise awareness to pay attention to vicinity.

27. The driving status detection device according to claim 1, wherein when the risk occurrence scene is detected, an occurrence location of the risk occurrence scene is detected by referring to electronic map data to estimate an occurrence object by which the risk occurrence scene is caused.

28. The driving status detection device according to claim 27, wherein a pedestrian crossing position and a bicycle running lane position are registered in the electronic map data to estimate that a pedestrian or a bicycle forms an occurrence object of the risk occurrence scene when an occurrence location of the risk occurrence scene lies near a pedestrian crossing or a bicycle running lane.

29. The driving status detection device according to claim 27, wherein traffic lane position and a center divider position are registered in the electronic map data to estimate that an oncoming vehicle during right-turn forms an occurrence object of the risk occurrence scene when an occurrence location of the risk occurrence scene lies near an oncoming lane or a center divider lane.

30. The driving status detection device according to claim 1, wherein the risk occurrence scene is registered as a history to detect a liable risk occurrence scene for the driver based on the history.

31. A driving status detection device detecting a characteristic driving status during a drive of a vehicle, comprising:
vehicle speed detection means for detecting a vehicle speed;
calculating means for calculating a differentiated value of second order of the vehicle speed within a given time interval; and
detecting means for detecting a risk occurrence scene that is a driving status at a high risk for a driver based on the differentiated value of second order of the vehicle speed.

32. A driving status detection method detecting a characteristic driving status during a drive of a vehicle, comprising:
detecting a vehicle speed;
calculating a differentiated value of second order of the vehicle speed within a given time interval; and
detecting a risk occurrence scene that is a driving status at a high risk for a driver based on the differentiated value of second order of the vehicle speed.

33. The driving status detection method according to claim 32, wherein when the risk occurrence scene is detected, a message is provided to raise awareness to the driver to pay attention to vicinity.

34. The driving status detection method according to claim 32, wherein when the risk occurrence scene is detected, an occurrence location of the risk occurrence scene is detected by referring to electronic map data to estimate an occurrence object by which the risk occurrence scene is caused.

35. The driving status detection device according to claim 34, wherein a pedestrian crossing position and a bicycle running lane position are registered in the electronic map data to estimate that a pedestrian or a bicycle forms an occurrence object of the risk occurrence scene when an occurrence location of the risk occurrence scene lies near a pedestrian crossing or a bicycle running lane.

36. The driving status detection device according to claim 34, wherein traffic lane position and a center divider position are registered in the electronic map data to estimate that an oncoming vehicle during right-turn forms an occurrence object of the risk occurrence scene when an occurrence location of the risk occurrence scene lies near an oncoming lane or a center divider lane.

37. The driving status detection device according to claim 32, wherein the risk occurrence scene is registered as a history to detect a liable risk occurrence scene for the driver based on the history.
